(19) United States
(12) Patent Application Publication
(10) Pub. No.: US 2026/0323024 A1
(43) Pub. Date: Oct. 15, 2026

(54) SEMANTIC TRANSMISSION OF IMAGE DATA

(71) Applicant: QUALCOMM Incorporated, San Diego, CA (US)

(72) Inventors: Chenxi Hao, Beijing (CN); Ruiming Zheng, Beijing (CN); Chao Wei, Beijing (CN); Juan Zhang, Beijing (CN); Rui Hu, Beijing (CN); Taesang Yoo, San Diego, CA (US); Hao Xu, Beijing (CN)

(21) Appl. No.: 19/483,563

(22) PCT Filed: Jun. 23, 2023
(86) PCT No.: PCT/CN2023/102004

§ 371 Date: Nov. 11, 2025

(51) Int. Cl. H04N 19/119; H04N 19/169

(52) U.S. Cl. CPC H04N 19/119; H04N 19/188

(57) ABSTRACT

This disclosure provides systems, methods, and apparatuses, including computer programs encoded on computer storage media, for wireless communication. In one aspect of the disclosure, a method for wireless communication performed by a user equipment (UE) includes apportioning semantic feature data associated with a semantically-encoded image or video frame into a plurality of portions in accordance with a modulation and coding scheme (MCS) and a resource allocation. The method includes hyperprior decoding compressed feature probability data associated with the semantic feature data. The method includes encoding each portion of the plurality of portions of the semantic feature data in association with a respective portion of a plurality of portions of the decoded feature probability data. The method includes transmitting a transport block (TB) that includes one or more of the encoded portions of the semantic feature data. Other aspects and features are also claimed and described.

### TECHNICAL FIELD

Aspects of the present disclosure relate generally to wireless communication systems, and more particularly, to semantic transmission of image data.

### DESCRIPTION OF THE RELATED TECHNOLOGY

Wireless communications systems are widely deployed to provide various types of communication content such as voice, video, packet data, messaging, broadcast, and so on. A wireless multiple-access communications system may include a number of base stations or network access nodes, each simultaneously supporting communication for multiple communication devices, which may be otherwise known as user equipment (UE). These systems may be capable of supporting communication with multiple UEs by sharing the available system resources (such as time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM).

Semantic communication has received growing interest for wireless communications because it can greatly reduce the amount of data to be transmitted while preserving the important aspects or meaning of the information to be transmitted. However, a challenge with semantic communication involves how precisely the transmitted signals or symbols convey the desired meaning. Semantic communication involves transmitting semantically-encoded information indicating a meaning or context of the information that is to be transmitted rather than the information itself. However, semantic communications over wireless communication systems, such as semantic communication of image information, requires accurate link adaptation and suffers greatly from channel degradation.

### SUMMARY

The following summarizes some aspects of the present disclosure to provide a basic understanding of the discussed technology. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

One innovative aspect of the subject matter described in this disclosure can be implemented in a method for wireless communication performed by a user equipment (UE). The method includes apportioning semantic feature data associated with a semantically-encoded image or video frame into a plurality of portions in accordance with a modulation and coding scheme (MCS) and a resource allocation; hyperprior decoding compressed feature probability data associated with the semantic feature data; encoding each portion of the plurality of portions of the semantic feature data in association with a respective portion of a plurality of portions of feature probability data; and transmitting a transport block (TB) that includes one or more of the encoded portions of the semantic feature data.

Another innovative aspect of the subject matter described in this disclosure can be implemented in a wireless communication device. The wireless communication device includes a processing system that includes processor circuitry and memory circuitry that stores code and is coupled with the processor circuitry. The processing system is configured to cause the wireless communication device to: apportion semantic feature data associated with a semantically-encoded image or video frame into a plurality of portions in accordance with a MCS and a resource allocation; hyperprior decode compressed feature probability data associated with the semantic feature data; encode each portion of the plurality of portions of the semantic feature data in association with a respective portion of a plurality of portions of the decoded feature probability data; and transmit a TB that includes one or more of the encoded portions of the semantic feature data.

Another innovative aspect of the subject matter described in this disclosure can be implemented in an apparatus configured for wireless communication. The apparatus includes means for apportioning semantic feature data associated with a semantically-encoded image or video frame into a plurality of portions in accordance with a MCS and a resource allocation; means for hyperprior decoding compressed feature probability data associated with the semantic feature data; means for encoding each portion of the plurality of portions of the semantic feature data in association with a respective portion of a plurality of portions of the decoded feature probability data; and means for transmitting a TB that includes one or more of the encoded portions of the semantic feature data.

Another innovative aspect of the subject matter described in this disclosure can be implemented in a non-transitory computer-readable medium storing instructions that, when executed by a processor, cause the processor to perform operations including apportioning semantic feature data associated with a semantically-encoded image or video frame into a plurality of portions in accordance with a MCS and a resource allocation; hyperprior decoding compressed feature probability data associated with the semantic feature data; encoding each portion of the plurality of portions of the semantic feature data in association with a respective portion of a plurality of portions of the decoded feature probability data; and transmitting a TB that includes one or more of the encoded portions of the semantic feature data.

Another innovative aspect of the subject matter described in this disclosure can be implemented in a method for wireless communication performed by a network entity. The method includes receiving a TB including one or more portions of encoded image data for an image or video frame for semantic decoding and one or more corresponding portions of compressed feature probability data; hyperprior decode each portion of the compressed feature probability data; and decode each portion of the encoded image data in association with a respective portion of a plurality of portions of the decoded feature probability data.

Another innovative aspect of the subject matter described in this disclosure can be implemented in a wireless communication device. The wireless communication device includes a processing system that includes one or more processors and one or more memories coupled with the one or more processors. The processing system is configured to cause the wireless communication device to: receive a TB including one or more portions of encoded image data for an image or video frame for semantic decoding and one or more corresponding portions of compressed feature probability data; hyperprior decode each portion of the compressed feature probability data; and decode each portion of the encoded image data in association with a respective portion of a plurality of portions of the decoded feature probability data.

Another innovative aspect of the subject matter described in this disclosure can be implemented in an apparatus configured for wireless communication. The apparatus includes means for receiving a TB including one or more portions of encoded image data for an image or video frame for semantic decoding and one or more corresponding portions of compressed feature probability data; means for hyperprior decoding each portion of the compressed feature probability data; and means for decoding each portion of the encoded image data in association with a respective portion of a plurality of portions of the decoded feature probability data.

Another innovative aspect of the subject matter described in this disclosure can be implemented in a non-transitory computer-readable medium storing instructions that, when executed by a processor, cause the processor to perform operations including receiving a TB including one or more portions of encoded image data for an image or video frame for semantic decoding and one or more corresponding portions of compressed feature probability data; hyperprior decode each portion of the compressed feature probability data; and decode each portion of the encoded image data in association with a respective portion of a plurality of portions of the decoded feature probability data.

Other aspects, features, and implementations of the present disclosure will become apparent to a person having ordinary skill in the art, upon reviewing the following description of specific, example implementations of the present disclosure in conjunction with the accompanying figures. While features of the present disclosure may be described relative to particular implementations and figures below, all implementations of the present disclosure can include one or more of the advantageous features described herein. In other words, while one or more implementations may be described as having particular advantageous features, one or more of such features may also be used in accordance with the various implementations of the disclosure described herein. In similar fashion, while example implementations may be described below as device, system, or method implementations, such example implementations can be implemented in various devices, systems, and methods.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of an example wireless communication system according to one or more aspects.

FIG. 2 is a block diagram illustrating examples of a base station and a user equipment (UE) according to one or more aspects.

FIG. 3 is a block diagram illustrating an example wireless communication system that supports semantic communication according to one or more aspects.

FIG. 4 is a block diagram illustrating an example wireless communication system that supports enhanced semantic communication operations according to one or more aspects.

FIG. 5 is a block diagram illustrating an example of distributed joint source and channel coding (JSCC) encoding according to one or more aspects.

FIG. 6 is a block diagram illustrating another example of distributed JSCC encoding according to one or more aspects.

FIG. 7 is a block diagram illustrating an example of distributed JSCC decoding according to one or more aspects.

FIG. 8 is a block diagram illustrating an example of allocation operations for enhanced semantic communication operations according to one or more aspects.

FIG. 9 is a flow diagram illustrating an example process that supports enhanced semantic communication operations according to one or more aspects.

FIG. 10 is a flow diagram illustrating an example process that supports enhanced semantic communication operations according to one or more aspects.

FIG. 11 is a block diagram of an example UE that supports enhanced semantic communication operations according to one or more aspects.

FIG. 12 is a block diagram of an example base station that supports enhanced semantic communication operations according to one or more aspects.

Like reference numbers and designations in the various drawings indicate like elements.

### DETAILED DESCRIPTION

Various aspects of the disclosure are described more fully hereinafter with reference to the accompanying drawings. This disclosure may, however, be embodied in many different forms and are not to be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

Various aspects relate generally to wireless communication, and more particularly, to semantic communication of image information. Some aspects more specifically relate to encoding and decoding of semantically-encoded image information using feature probability information and signaling for supporting semantic communication of image information. In some examples, a wireless communication device may encode portions of semantic feature data associated with a semantically-encoded image or video frame using respective portions of feature probability data. Each portion of semantic feature data and portion of feature probability data may correspond to a portion of the image or video frame. The wireless communication device then transmits the encoded portions of the semantic feature data and the portions of feature probability data wirelessly for decoding by another wireless communication device. The other wireless communication devices then decodes the encoded portions of semantic feature data using the respective portions of feature probability data.

In some implementations, the semantic communication of portions of image information may include one or more allocation operations to generate the portions of the data used in semantic communication. For example, the wireless communication device may include an allocator to allocate one or more first portions of data into one or more second portions of data. The allocator may segment and/or combine the first portions to generate the second portions. Additionally, the allocator may generate intermediary portions and generate the second portions based on segmenting or combining any of the first portions and/or the intermediary portions. The feature probability information may be segmented and/or assembled in the same way as its respective semantic feature data is. In some such implementations, the allocator may correspond to layers of a 5G processing stack and the one or more allocation operations may be performed by different layers of the 5G processing stack. The semantic communication of portions of image information reduces a burden on modem processing and enables the wireless communication device to encode and transmit image information which would otherwise exceed chipset memory.

In some implementations, the encoding of each portion of semantic feature data involves performing joint source and channel coding (JSCC) encoding. For example, the wireless communication device may include a plurality of JSCC encoders to JSCC encode the portions of semantically encoded image data using the feature probability information, to perform combined source and channel encoding of the semantically encoded image information (semantic feature data). Additionally, the JSCC encoding may include or correspond to “deep” JSCC encoding and utilize artificial intelligence (AI) or machine learning (ML) model information to perform the JSCC encoding. JSCC encoding of the semantically encoded image information may enable a wireless communication device to enable JSCC encoding of higher resolution images without a performance degradation often experienced by JSCC encoding alone (JSCC encoding raw image data) and may enable preventing a cliff effect often experienced when semantic coding or non-linear transform coding (NTC) is used alone. In some such implementations, the JSCC encoding involves performing distributed JSCC encoding at the physical layer.

Particular aspects of the subject matter described in this disclosure can be implemented to realize one or more of the following potential advantages. In some examples, by semantically communicating image information, the described techniques can be used to reduce a bandwidth used to transmit image information and/or can be used to transmit larger quantities of image information with a given bandwidth. For example, semantically encoding the image information by meaning or context (as opposed to pixel value) enables a greater data compression. Increasing the data compression reduces the space or bandwidth needed to transmit the image information and also allows larger images (e.g., more pixels, such as by physically larger images or higher resolution images) to be transmitted in a particular wireless bandwidth or channel.

In some examples, by utilizing JSCC encoding with semantic encoding (e.g., semantically-encoded information), the described techniques can be used to reduce cliff effects. Using JSCC encoding with semantic encoding enables reduced cliff effects in general, such as due to channel degradation and cliff effects caused by semantic encoding information that has a source code rate higher than then a channel capacity. The cliff effect is a phenomenon evidenced when the quality of received data drops abruptly when the channel quality falls below the channel capacity or another threshold and does not improve once the channel quality surpasses this point. Using JSCC encoding with semantic encoding also enables better performance of high resolution images than JSCC alone, as JSCC encoding can adapt the source coding rate with the channel capacity. In some examples, by utilizing distributed coding, the described techniques can be used to enable semantic communication of image information via wireless channels. Using multiple hyperprior coders and JSCC coders enables increased processing throughput and reduced processing latency.

In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5th Generation (5G) or new radio (NR) networks (sometimes referred to as “5G NR” networks, systems, or devices), as well as other communications networks. As described herein, the terms “networks” and “systems” may be used interchangeably. In some implementations, two or more wireless communications systems, also referred to as wireless communications networks, may be configured to provide or participate in authorized shared access between the two or more wireless communications systems.

A CDMA network may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may implement a radio technology such as Global System for Mobile Communications (GSM). 3GPP defines standards for the GSM EDGE (enhanced data rates for GSM evolution) radio access network (RAN), also denoted as GERAN. GERAN is the radio component of GSM or GSM EDGE, together with the network that joins the base stations (for example, the Ater and Abis interfaces, among other examples) and the base station controllers (for example, A interfaces, among other examples). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may include one or more GERANs, which may be coupled with UTRANs in the case of a UMTS or GSM network. Additionally, an operator network may include one or more LTE networks, or one or more other networks. The various different network types may use different radio access technologies (RATs) and radio access networks (RANs).

An OFDMA network may implement a radio technology such as evolved UTRA (E-UTRA), IEEE 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named the “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP long term evolution (LTE) is a 3GPP project aimed at improving the universal mobile telecommunications system (UMTS) mobile phone standard. The 3GPP may define specifications for the next generation of mobile networks, mobile systems, and mobile devices. The present disclosure may describe certain aspects with reference to LTE, 4G, 5G, or NR technologies; however, the description is not intended to be limited to a specific technology or application, and one or more aspects described with reference to one technology may be understood to be applicable to another technology. Indeed, one or more aspects the present disclosure are related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (such as ~1M nodes per km2), ultra-low complexity (such as ~10 s of bits per sec), ultra-low energy (such as ~10+ years of battery life), and deep coverage with the capability to reach challenging locations; (2) including mission-critical control with strong security to safeguard sensitive personal, financial, or classified information, ultra-high reliability (such as ~99.9999% reliability), ultra-low latency (such as ~1 millisecond (ms)), and users with wide ranges of mobility or lack thereof; and (3) with enhanced mobile broadband including extreme high capacity (such as ~10 Tbps per km2), extreme data rates (such as multi-Gbps rate, 100+ Mbps user experienced rates), and deep awareness with advanced discovery and optimizations.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) or frequency division duplex (FDD) design; and advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD or TDD implementations, subcarrier spacing may occur with 15 kHz, for example over 1, 5, 10, 20 MHz, and the like bandwidth. For other various outdoor and small cell coverage deployments of TDD greater than 3 GHZ, subcarrier spacing may occur with 30 kHz over 80 or 100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mm Wave components at a TDD of 28 GHz, subcarrier spacing may occur with 120 kHz over a 500 MHz bandwidth.

The scalable numerology of 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

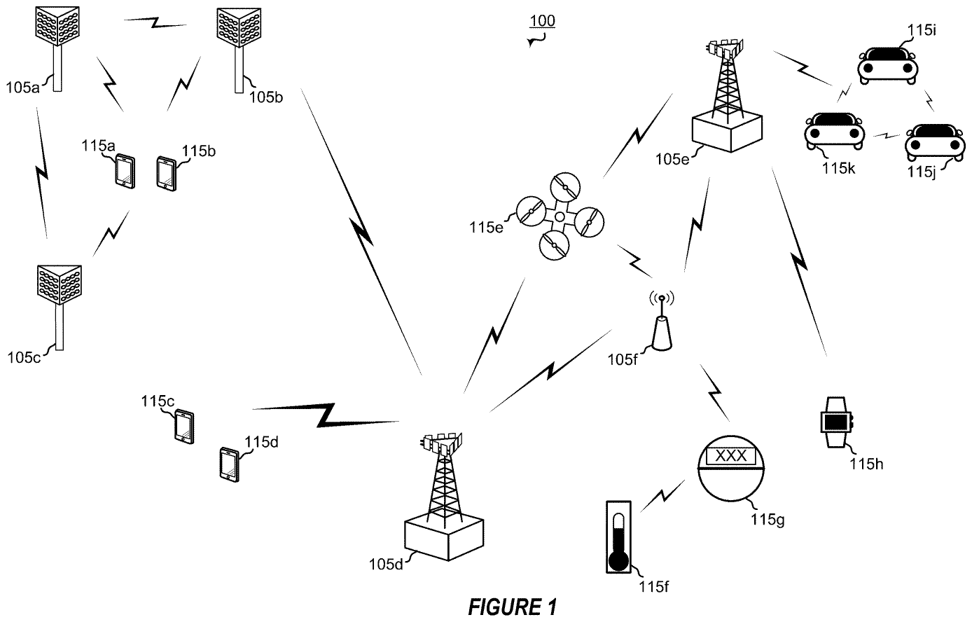

FIG. 1 is a block diagram illustrating details of an example wireless communication system. The wireless communication system may include wireless network 100. The wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements, such as device-to-device, peer-to-peer or ad hoc network arrangements, among other examples.

The wireless network 100 illustrated in FIG. 1 includes a number of base stations 105 and other network entities. A base station may be a station that communicates with the UEs and may be referred to as an evolved node B (eNB), a next generation eNB (gNB), an access point, and the like. Each base station 105 may provide communication coverage for a particular geographic area. In 3GPP, the term “cell” can refer to this particular geographic coverage area of a base station or a base station subsystem serving the coverage area, depending on the context in which the term is used. In implementations of the wireless network 100 herein, the base stations 105 may be associated with a same operator or different operators, such as the wireless network 100 may include a plurality of operator wireless networks. Additionally, in implementations of the wireless network 100 herein, the base stations 105 may provide wireless communications using one or more of the same frequencies, such as one or more frequency bands in licensed spectrum, unlicensed spectrum, or a combination thereof, as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area, such as several kilometers in radius, and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area, such as a home, and, in addition to unrestricted access, may provide restricted access by UEs having an association with the femto cell, such as UEs in a closed subscriber group (CSG), UEs for users in the home, and the like. A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple cells, such as two cells, three cells, four cells, and the like.

The wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

The UEs 115 are dispersed throughout the wireless network 100, and each UE may be stationary or mobile. It should be appreciated that, although a mobile apparatus is commonly referred to as user equipment (UE) in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. Within the present document, a “mobile” apparatus or UE need not necessarily have a capability to move, and may be stationary. Some non-limiting examples of a mobile apparatus, such as may include implementations of one or more of the UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an “Internet of things” (IoT) or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, a gesture tracking device, a medical device, a digital audio player (such as MP3 player), a camera or a game console, among other examples; and digital home or smart home devices such as a home audio, video, and multimedia device, an appliance, a sensor, a vending machine, intelligent lighting, a home security system, or a smart meter, among other examples. In one aspect, a UE may be a device that includes a Universal Integrated Circuit Card (UICC). In another aspect, a UE may be a device that does not include a UICC. In some aspects, UEs that do not include UICCs may be referred to as IoE devices. The UEs 115a-115d of the implementation illustrated in FIG. 1 are examples of mobile smart phone-type devices accessing the wireless network 100. A UE may be a machine specifically configured for connected communication, including machine type communication (MTC), enhanced MTC (eMTC), narrowband IoT (NB-IoT) and the like. The UEs 115e-115k illustrated in FIG. 1 are examples of various machines configured for communication that access 5G network 100.

A mobile apparatus, such as the UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. Backhaul communication between base stations of the wireless network 100 may occur using wired or wireless communication links.

In operation at the 5G network 100, the base stations 105a-105c serve the UEs 115a and 115b using 3D beamforming and coordinated spatial techniques, such as coordinated multipoint (CoMP) or multi-connectivity. Macro base station 105d performs backhaul communications with the base stations 105a-105c, as well as small cell, the base station 105f. Macro base station 105d also transmits multicast services which are subscribed to and received by the UEs 115c and 115d. Such multicast services may include mobile television or stream video, or may include other services for providing community information, such as weather emergencies or alerts, such as Amber alerts or gray alerts.

The wireless network 100 of implementations supports mission critical communications with ultra-reliable and redundant links for mission critical devices, such the UE 115e, which is a drone. Redundant communication links with the UE 115e include from the macro base stations 105d and 105e, as well as small cell base station 105f. Other machine type devices, such as UE 115f (thermometer), the UE 115g (smart meter), and the UE 115h (wearable device) may communicate through the wireless network 100 either directly with base stations, such as the small cell base station 105f, and the macro base station 105e, or in multi-hop configurations by communicating with another user device which relays its information to the network, such as the UE 115f communicating temperature measurement information to the smart meter, the UE 115g, which is then reported to the network through the small cell base station 105f. The 5G network 100 may provide additional network efficiency through dynamic, low-latency TDD or FDD communications, such as in a vehicle-to-vehicle (V2V) mesh network between the UEs 115i-115k communicating with the macro base station 105e.

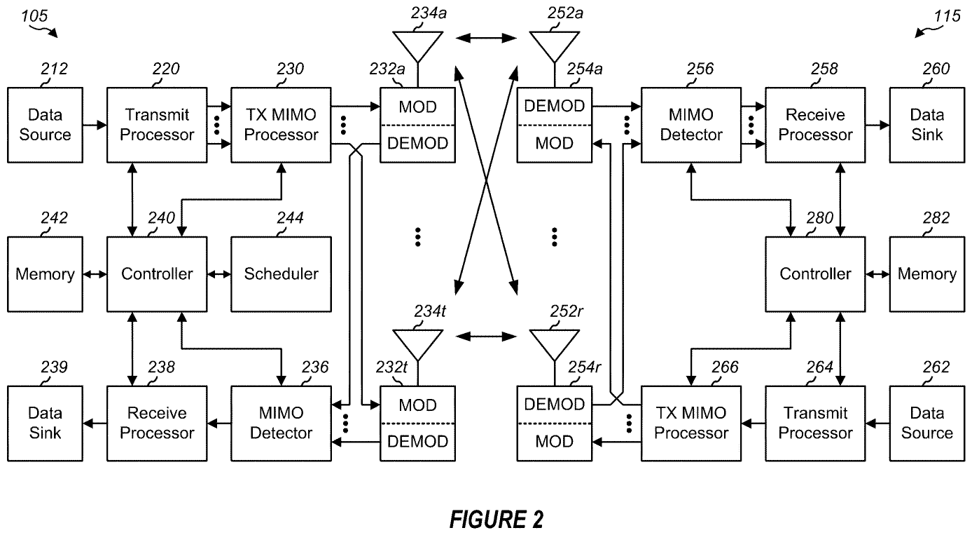

FIG. 2 is a block diagram conceptually illustrating an example design of a base station 105 and a UE 115. The base station 105 and the UE 115 may be one of the base stations and one of the UEs in FIG. 1. For a restricted association scenario (as mentioned above), the base station 105 may be the small cell base station 105f in FIG. 1, and the UE 115 may be the UE 115c or 115d operating in a service area of the base station 105f, which in order to access the small cell base station 105f, would be included in a list of accessible UEs for the small cell base station 105f. Additionally, the base station 105 may be a base station of some other type. As shown in FIG. 2, the base station 105 may be equipped with antennas 234a through 234t, and the UE 115 may be equipped with antennas 252a through 252r for facilitating wireless communications.

At the base station 105, a transmit processor 220 may receive data from a data source 212 and control information from a controller 240. The control information may be for the physical broadcast channel (PBCH), physical control format indicator channel (PCFICH), physical hybrid-ARQ (automatic repeat request) indicator channel (PHICH), physical downlink control channel (PDCCH), enhanced physical downlink control channel (EPDCCH), or MTC physical downlink control channel (MPDCCH), among other examples. The data may be for the PDSCH, among other examples. The transmit processor 220 may process, such as encode and symbol map, the data and control information to obtain data symbols and control symbols, respectively. Additionally, the transmit processor 220 may generate reference symbols, such as for the primary synchronization signal (PSS) and secondary synchronization signal (SSS), and cell-specific reference signal. Transmit (TX) multiple-input multiple-output (MIMO) processor 230 may perform spatial processing on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream, such as for OFDM, among other examples, to obtain an output sample stream. Each modulator 232 may additionally or alternatively process the output sample stream to obtain a downlink signal. For example, to process the output sample stream, each modulator 232 may convert to analog, amplify, filter, and upconvert the output sample stream to obtain the downlink signal. Downlink signals from modulators 232a through 232t may be transmitted via the antennas 234a through 234t, respectively.

At the UE 115, the antennas 252a through 252r may receive the downlink signals from the base station 105 and may provide received signals to the demodulators (DEMODs) 254a through 254r, respectively. Each demodulator 254 may condition a respective received signal to obtain input samples. For example, to condition the respective received signal, each demodulator 254 may filter, amplify, downconvert, and digitize the respective received signal to obtain the input samples. Each demodulator 254 may further process the input samples, such as for OFDM, among other examples, to obtain received symbols. MIMO detector 256 may obtain received symbols from demodulators 254a through 254r, perform MIMO detection on the received symbols if applicable, and provide detected symbols. Receive processor 258 may process the detected symbols, provide decoded data for the UE 115 to a data sink 260, and provide decoded control information to a controller 280. For example, to process the detected symbols, the receive processor 258 may demodulate, deinterleave, and decode the detected symbols.

On the uplink, at the UE 115, a transmit processor 264 may receive and process data (such as for the physical uplink shared channel (PUSCH)) from a data source 262 and control information (such as for the physical uplink control channel (PUCCH)) from the controller 280. Additionally, the transmit processor 264 may generate reference symbols for a reference signal. The symbols from the transmit processor 264 may be precoded by TX MIMO processor 266 if applicable, further processed by the modulators 254a through 254r (such as for SC-FDM, among other examples), and transmitted to the base station 105. At base station 105, the uplink signals from the UE 115 may be received by antennas 234, processed by demodulators 232, detected by MIMO detector 236 if applicable, and further processed by receive processor 238 to obtain decoded data and control information sent by the UE 115. The receive processor 238 may provide the decoded data to data sink 239 and the decoded control information to the controller 240.

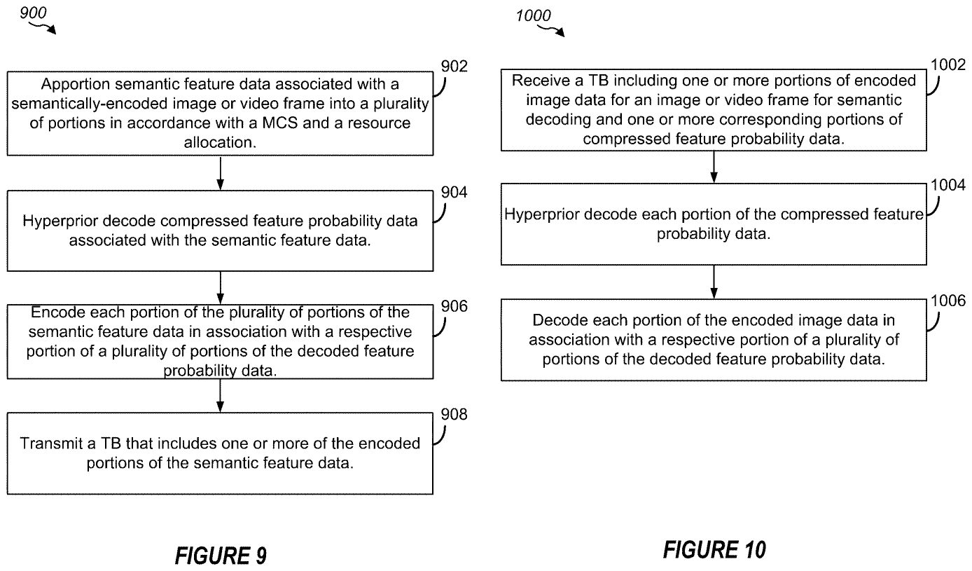

The controllers 240 and 280 may direct the operation at the base station 105 and the UE 115, respectively. The controller 240 or other processors and modules at the base station 105 or the controller 280 or other processors and modules at the UE 115 may perform or direct the execution of various processes for the techniques described herein, such as to perform or direct the execution illustrated in FIGS. 9 and 10, or other processes for the techniques described herein. The memories 242 and 282 may store data and program codes for the base station 105 and The UE 115, respectively. Scheduler 244 may schedule UEs for data transmission on the downlink or uplink.

In some cases, the UE 115 and the base station 105 may operate in a shared radio frequency spectrum band, which may include licensed or unlicensed, such as contention-based, frequency spectrum. In an unlicensed frequency portion of the shared radio frequency spectrum band, the UEs 115 or the base stations 105 may traditionally perform a medium-sensing procedure to contend for access to the frequency spectrum. For example, the UE 115 or base station 105 may perform a listen-before-talk or listen-before-transmitting (LBT) procedure such as a clear channel assessment (CCA) prior to communicating in order to determine whether the shared channel is available. A CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. In some implementations, a CCA may include detection of specific sequences that indicate use of the channel. For example, another device may transmit a specific preamble prior to transmitting a data sequence. In some cases, an LBT procedure may include a wireless node adjusting its own back off window based on the amount of energy detected on a channel or the acknowledge or negative-acknowledge (ACK or NACK) feedback for its own transmitted packets as a proxy for collisions.

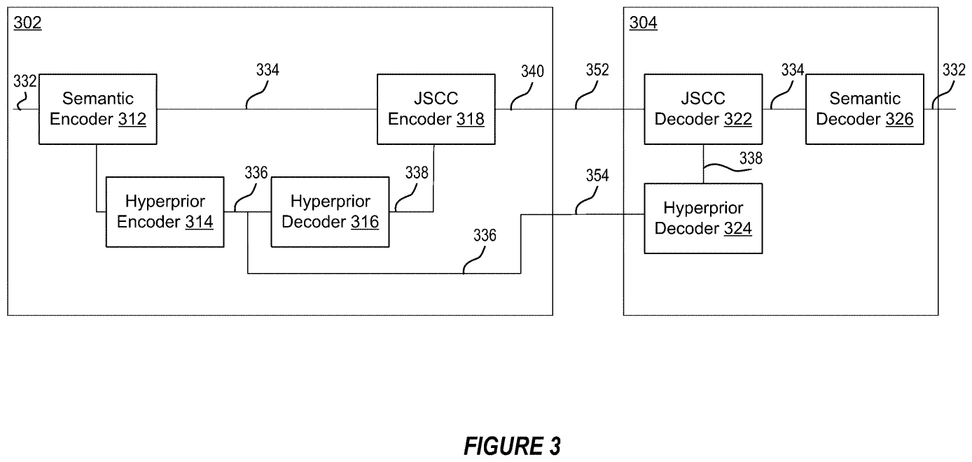

FIG. 3 depicts an example configuration for semantic transmission of source information, which can be text, image or video, etc. FIG. 3 is described with reference to an example of JSCC encoding and decoding for semantically encoded image data.

In FIG. 3, a first wireless communication device 302, such as an encoding system or processing system thereof, includes a semantic encoder 312, a hyperprior encoder 314, a hyperprior decoder 316, and a JSCC encoder 318. The first wireless communication device 302, such as the encoding system or processing system thereof, is configured to semantically encode image information for wireless transmission.

In FIG. 3, a second wireless communication device 304, such as an decoding system or processing system thereof, includes a JSCC decoder 322, a hyperprior decoder 324, and a semantic decoder 326. The second wireless communication device 304, such as the decoding system or processing system thereof, is configured to perform decode semantically encoded image information received wirelessly.

During operation, the semantic encoder 312 receives image data 332 and generates semantic feature data 334 based on processing (semantically encoding) the image data 332. The semantic encoder 312 provides the semantic feature data 334 to the hyperprior encoder 314 and to the JSCC encoder 318.

The hyperprior encoder 314 receives the semantic feature data 334 and generates compressed feature probability data 336 based on processing (hyperprior encoding) the semantic feature data 334. The hyperprior encoder 314 provides the compressed feature probability data 336 to the hyperprior decoder 316 and to the second wireless communication device 304 as side information via a second wireless channel 344.

The hyperprior decoder 316 receives the compressed feature probability data 336 and generates (decompressed) feature probability data 338 based on processing (hyperprior decoding) the compressed feature probability data 336. The hyperprior decoder 316 provides the feature probability data 338 to the JSCC encoder 318.

The JSCC encoder 318 receives the semantic feature data 334 and the (decompressed) feature probability data 338, and generates encoded semantic feature data 340 based on processing (JSCC encoding) the semantic feature data 334 in accordance with the feature probability data 338. The JSCC encoder 318 provides the encoded semantic feature data 340 to the second wireless communication device 304 as encoded data for semantic communication via a first wireless channel 342.

The second wireless communication device 304 receives the encoded semantic feature data 340 via the first wireless channel 342 and the side information (e.g., the compressed feature probability data 336) via the second wireless channel 344. The second wireless communication device 304 provides the encoded semantic feature data 340 to the JSCC decoder 322 and the side information (e.g., the compressed feature probability data 336) to the hyperprior decoder 324.

The hyperprior decoder 324 receives the compressed feature probability data 336 and generates (decompressed) feature probability data 338 based on processing (hyperprior decoding) the compressed feature probability data 336. The hyperprior decoder 324 provides the feature probability data 338 to the JSCC decoder 322.

The JSCC decoder 322 receives the encoded semantic feature data 340 and the (decompressed) feature probability data 338, and generates semantic feature data 334 based on processing (JSCC decoding) the semantic feature data 334 in accordance with the feature probability data 338. The JSCC decoder 322 provides the (decoded) semantic feature data 334 to the semantic decoder 326.

The semantic decoder 326 receives the semantic feature data 334 and generates image data 332 based on processing (semantically decoding) the semantic feature data 334. The semantic decoder 326 provides the image data 332 to another element of the second wireless communication device 304, such as for storage or display or an image corresponding to the image data 332.

Accordingly, FIG. 3 illustrates an example of semantic encoding for wireless transmission of semantically encoded image information. The semantic encoding of FIG. 3, may enable a wireless network to transmit semantically-encoded information of text or low resolution images.

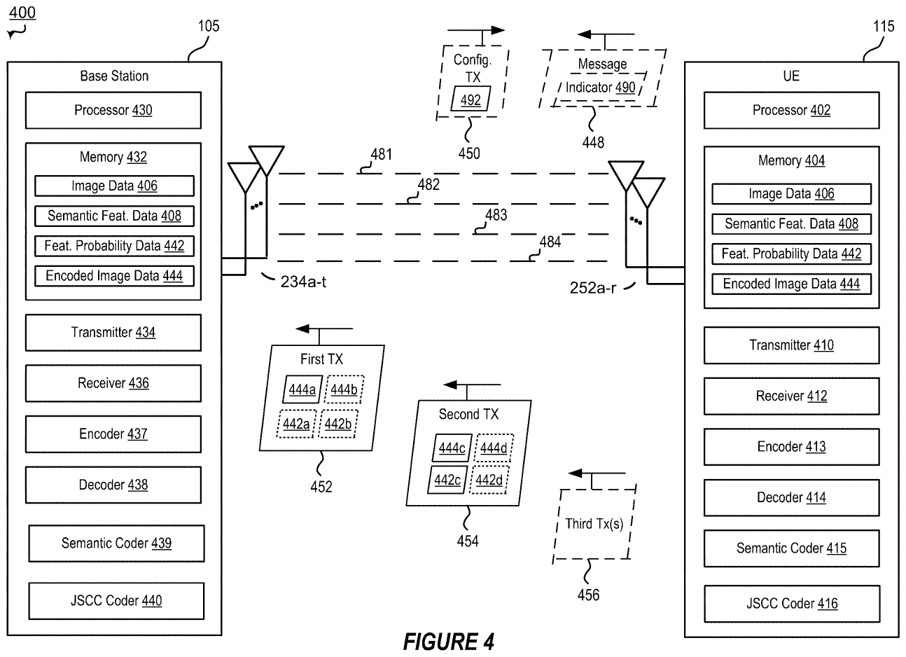

FIG. 4 illustrates an example of a wireless communications system 400 that supports enhanced semantic communication operations in accordance with aspects of the present disclosure. In some examples, wireless communications system 400 may implement aspects of wireless communication system 100. For example, wireless communications system 400 may include a network, such as one or more network entities, and one or more UEs, such as UE 115. As illustrated in the example of FIG. 4, the network entity includes a corresponds to a base station, such as base station 105. Alternatively, the network entity may include or correspond to a different network device (e.g., not a base station). Enhanced semantic communication operations may improve data compression and reduce bandwidths used to transmit high resolution image or video information. Additionally, the enhanced semantic communication operations may enable the transmission of more information per a particular bandwidth or channel capacity. Enhanced semantic communication operations, such as JSCC coding semantically-encoded information, may further reduce the issues with both semantic coding of image information and JSCC coding of image information. Accordingly, network and device performance can be increased. Moreover, enhanced semantic communication operations, such as distributed processing or coding, may reduce latency and failures due to semantic coding and further joint and/or source coding, such as due to receipt of uplink data after it is valid. These improvements may reduce latency and increase throughput by improving connection quality and reducing retransmission of data and failures. Accordingly, network and device performance can be increased.

Base station 105 and UE 115 may be configured to communicate via one or more portions of the electromagnetic spectrum. The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “mmWave” band in documents and articles, despite being different from the extremely high frequency (EHF) band (30 GHz-300 GHz) which is identified by the International Telecommunications Union (ITU) as a “mm Wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “mm Wave” or the like if used herein may broadly represent frequencies that may include mid-band frequencies, may be within FR2, or may be within the EHF band.

It is noted that SCS may be equal to 15, 30, 60, or 120 kHz for some data channels. Base station 105 and UE 115 may be configured to communicate via one or more component carriers (CCs), such as representative first CC 481, second CC 482, third CC 483, and fourth CC 484. Although four CCs are shown, this is for illustration only, more or fewer than four CCs may be used. One or more CCs may be used to communicate control channel transmissions, data channel transmissions, and/or sidelink channel transmissions.

Such transmissions may include a Physical Downlink Control Channel (PDCCHI), a Physical Downlink Shared Channel (PDSCH), a Physical Uplink Control Channel (PUCCH), a Physical Uplink Shared Channel (PUSCH), a Physical Sidelink Control Channel (PSCCH), a Physical Sidelink Shared Channel (PSSCH), or a Physical Sidelink Feedback Channel (PSFCH). Such transmissions may be scheduled by aperiodic grants and/or periodic grants.

Each periodic grant may have a corresponding configuration, such as configuration parameters/settings. The periodic grant configuration may include configured grant (CG) configurations and settings. Additionally, or alternatively, one or more periodic grants (e.g., CGs thereof) may have or be assigned to a CC ID, such as intended CC ID.

Each CC may have a corresponding configuration, such as configuration parameters/settings. The configuration may include bandwidth, bandwidth part, HARQ process, TCI state, RS, control channel resources, data channel resources, or a combination thereof. Additionally, or alternatively, one or more CCs may have or be assigned to a Cell ID, or a Bandwidth Part (BWP) ID. The Cell ID may include a unique cell ID for the CC, a virtual Cell ID, or a particular Cell ID of a particular CC of the plurality of CCs. Additionally, or alternatively, one or more CCs may have or be assigned to a HARQ ID. Each CC may also have corresponding management functionalities, such as, beam management or BWP switching functionality. In some implementations, two or more CCs are quasi co-located, such that the CCs have the same beam and/or same symbol.

In some implementations, control information may be communicated via base station 105 and UE 115. For example, the control information may be communicated suing MAC-CE transmissions, RRC transmissions, DCI (downlink control information) transmissions, UCI (uplink control information) transmissions, SCI (sidelink control information) transmissions, another transmission, or a combination thereof.

UE 115 can include a variety of components (e.g., structural, hardware components) used for carrying out one or more functions described herein. For example, these components can includes processor 402, memory 404, transmitter 410, receiver 412, encoder, 413, decoder 414, semantic coder 415, JSCC coder 416, and antennas 252a-r. Processor 402 may be configured to execute instructions stored at memory 404 to perform the operations described herein. In some implementations, processor 402 includes or corresponds to controller/processor 280, and memory 404 includes or corresponds to memory 282. Memory 404 may also be configured to store image data 406, semantic feature data 408, feature probability data 442, encoded image data 444, settings data, or a combination thereof, as further described herein.

The image data 406 includes or corresponds to data associated with or corresponding to an image, such as an image frame or video frame. For example, the image data 406 may include or correspond to raw image information for a high quality or high resolution image and/or for a larger image, such as an image with. The image data 406 may include or correspond to pixel information and be represented in an image domain of height, width, and a number of color channels (e.g., H*W*C).

In some implementations, the image data 406 may be represented by multiple portions or pieces of image data. Each portion or piece of image data 406 may be associated with a particular segment or portion of the image, often referred to as chunk of the image or image chunk. For example, the image may have a plurality of chunks or patches each having a dimension of h*w.

The semantic feature data 408 includes or corresponds to data associated with or corresponding semantically encoded image data. For example, the semantic feature data 408 may include or correspond to information indicating a meaning or context of the image data 406. To illustrate, the semantic feature data 408 includes information indicating a plurality of features of the image data 406. The semantic feature data 408 may be indicated in a feature space domain, such as Hp*Wp*d. The feature space dimension has a reduced value for the height and the width as compared to a corresponding value for the height and the width of the image dimension of the image data 406. The feature space dimension has an increased value for the weight as compared to a corresponding value of the color channel of the image dimension of the image data 406. For example, for an image in an image dimension of 1024*1024*3, the feature space domain may be 64*64*256.

In some implementations, the semantic feature data 408 may be represented by multiple portions or pieces of semantic feature data. Each portion or piece of semantic feature data 408 may be associated with a particular segment or portion of the image, often referred to as chunk of the image or image chunk and correspond to a particular portion of the image data 406. For example, a particular portion of the semantic feature data 408 may indicate features of a corresponding portion of the image data 406. Each portion of the image data 406 and semantic feature data 408 may have different features. The size of the portions (e.g., allocation size) may align with dimensions (e.g., input dimension) associated with the JSCC and/or hyperprior coders. For example, the size of the portions may correspond to a size of the model information for the JSCC coder, the hyperprior coder, or both. In some implementations, each portion should include or correspond to an entire embedding feature of multiple patches of the image, hp*wp*d where d is the dimension of embedding feature, hp is the number of patches in height, wp is the number of patches in width.

The feature probability data 442 (e.g., side information for semantic information) includes or corresponds to data associated with or corresponding to probability information for the features of the semantic feature data 408. For example, the feature probability data 442 may indicate a probability or occurrence rate for one or more features of the semantic feature data 408. As another example, the feature probability data 442 may indicate a number of occurrences or instances of one or more features of the semantic feature data 408.

In some implementations, the feature probability data 442 may be represented by multiple portions or pieces of feature probability data. Each portion or piece of feature probability data 442 may be associated with a particular segment or portion of the image, often referred to as chunk of the image or image chunk and correspond to a particular portion of the semantic feature data 408. For example, a particular portion of the feature probability data 442 may indicate a probability or occurrence rate for each feature of a corresponding portion of the semantic feature data 408. Each portion of the semantic feature data 408 may have different features, and each portion of the feature probability data 442 may have different rates of occurrence for those features or instances of the features.

The feature probability data 442 may include one or more versions or types of feature probability data. For example, the feature probability data 442 may include uncompressed or decompressed feature probability data. compressed feature probability data, encoded feature probability data, or a combination thereof. Compressed feature probability data may include or correspond to feature probability data which is in a compressed format, such as feature probability data which is generated by encoding the semantic feature data 408, such as hyperprior encoding the semantic feature data 408. Uncompressed or decompressed feature probability data may include or correspond to feature probability data which is in an uncompressed format, such as feature probability data which is generated by decoding compressed feature probability data from a hyperprior encoder, such as hyperprior decoding the compressed feature probability data. The uncompressed feature probability data may be used by an encoder (e.g., JSCC encoder) to further encode the semantic feature data.

Encoded feature probability data may include or correspond to feature probability data which is in a compressed and encoded format, such as encoded compressed feature probability data which is generated by further encoding (e.g., entropy and channel coding) the compressed feature probability data from the hyperprior encoder, such as entropy and channel coding the compressed feature probability data. As the compressed feature probability data may correspond to text data, (e.g. may not be semantically encoded data or data representing a context or meaning), such data can be further compressed by separate source and channel coding.

The encoded image data 444 (e.g., semantic and JSCC encoded image data or encoded data for semantic information) includes or corresponds to image data which has been semantically encoded and JSCC encoded. For example, the encoded image data 444 may include or correspond to an encoded version of the semantic feature data 408. To illustrate, the encoded image data 444 may include or correspond to encoded information indicating the meaning or context of the image data 406, such as encoded semantic feature information or encoded information indicating the features of the image data 406.

In some implementations, the encoded image data 444 may be represented by multiple portions or pieces of encoded image data. Each piece of encoded image data 444 may be associated with a particular segment or portion of the image, often referred to as chunk of the image or image chunk and correspond to a particular portion of the image data 406, the semantic feature data 408, the feature probability data 442, or a combination thereof. For example, a particular portion of the encoded image data 444 may indicate encoded feature information for a corresponding portion of the image data 406 and the semantic feature data 408.

The settings data includes or corresponds to data associated with enhanced semantic communication operations. The settings data may include one or more types of enhanced semantic encoding or decoding modes and/or thresholds or conditions for switching between enhanced semantic communication modes and/or configurations thereof, switching between semantic communication and non-semantic communication modes, or both. For example, the settings data may have data indicating different thresholds and/or conditions for different enhanced semantic communication modes, such non-distributed modes, distributed modes, JSCC modes, segmentation modes, etc., or a combination thereof.

The UE 115 may further include other types of data, such as coding model information. The coding model information may include semantic encoding mode information, semantic decoding mode information, hyperprior encoding mode information, hyperprior decoding mode information, JSCC encoding mode information, JSCC decoding mode information, or a combination thereof. The coding model information, or one or more portions thereof, may include or corresponding to artificial intelligence (AI) or machine learning (ML) model information and may be generated based or by using AI or ML techniques. For example, the JSCC encoder may utilize AI and/or ML techniques and may encode or decode data using model information generated based on AI or ML operations.

Transmitter 410 is configured to transmit data to one or more other devices, and receiver 412 is configured to receive data from one or more other devices. For example, transmitter 410 may transmit data, and receiver 412 may receive data, via a network, such as a wired network, a wireless network, or a combination thereof. For example, UE 115 may be configured to transmit and/or receive data via a direct device-to-device connection, a local area network (LAN), a wide area network (WAN), a modem-to-modem connection, the Internet, intranet, extranet, cable transmission system, cellular communication network, any combination of the above, or any other communications network now known or later developed within which permits two or more electronic devices to communicate. In some implementations, transmitter 410 and receiver 412 may be replaced with a transceiver. Additionally, or alternatively, transmitter 410 or receiver, 412 may include or correspond to one or more components of UE 115 described with reference to FIG. 2.

Encoder 413 and decoder 414 may be configured to encode and decode data for transmission. Semantic coder 415 may be configured to perform semantic coding or communication operations, such as semantic encoding operations, semantic decoding operations, or both. For example, the semantic coder 415 may be configured to generate encoded semantic feature data 408 based on the image data 406 in accordance with semantic model information. To illustrate, the semantic coder 415 may be configured to identify features of the image data 406 based on semantic model information and generate the semantic feature data 408 indicating a meaning or features of the image data 406.

As another example, the semantic coder 415 may be configured to decode the semantic feature data 408 (the semantically encoded image data), such as to reverse the semantic encoding process. To illustrate, the semantic coder 415 may be configured to generate the image data 406 based on the semantic feature data 408 and using the semantic model information. The semantic coding may include or correspond to non-linear transform coding (NTC). For example, the semantic coding may utilize a transform and entropy model (transform and entropy model information).

The semantic coder 415 may be configured to perform semantic coding on portions of image data transmitted in wireless communications. The semantic coder 415 may be configured to encode or decode portions of the image data 406 or the semantic feature data 408, such as discrete segments or chunks of the image or video frame. In some implementations, the semantic coder 415 may include one or more semantic coders, such as one or more semantic encoders, one or more semantic decoders, or both. Each semantic coder may correspond to a receive or transmit chain of the UE 115 and may be configured to semantically code portions of the image data 406 or semantic feature data 408.

JSCC coder 416 may be configured to perform JSCC operations, such as JSCC encoding operations, JSCC decoding operations, or both. For example, the JSCC coder 416 may be configured to generate encoded image data 444 based on the semantic feature data 408 and the feature probability data 442, and in accordance with JSCC model information. To illustrate, the JSCC coder 416 may be configured to generate encoded image data 444 based on the semantic feature data 408 and using the feature probability data 442. As another example, the JSCC coder 416 may be configured to decode the encoded image data 444, such as to reverse the encoding process. To illustrate, the JSCC coder 416 may be configured to generate the semantic feature data 408 based on the encoded image data 444 and using the feature probability data 442.

The JSCC coder 416 may be configured to perform a portion of the source and channel coding used in wireless communication. The JSCC coder 416 may be configured to encode or decoder portions of the semantic feature data 408 or the encoded image data 444. In some implementations, the JSCC coder 416 may include one or more JSCC coders, such as one or more JSCC encoders, one or more JSCC decoders, or both. Each JSCC coder may correspond to a receive or transmit chain and may be configured to JSCC code portions of the semantic feature data 408 or the encoded image data 444.

Additionally, or alternatively, the JSCC coder 416 may include one or more hyperprior coders, such as one or more hyperprior encoders, one or more hyperprior decoders, or a combination thereof. In some implementations, each JSCC coder may have a corresponding hyperprior coder. For example, each JSCC coder may have a corresponding hyperprior decoder, a corresponding hyperprior encoder, or both. Alternatively, the one or more hyperprior coders may be separate from the JSCC coder 416. The hyperprior coders may generate or process side information for use by the JSCC coder 416. For example, a hyperprior encoder may generate compressed feature probability data based on the semantic feature data, and a hyperprior decoder may generate uncompressed feature probability data based on the compressed feature probability data.

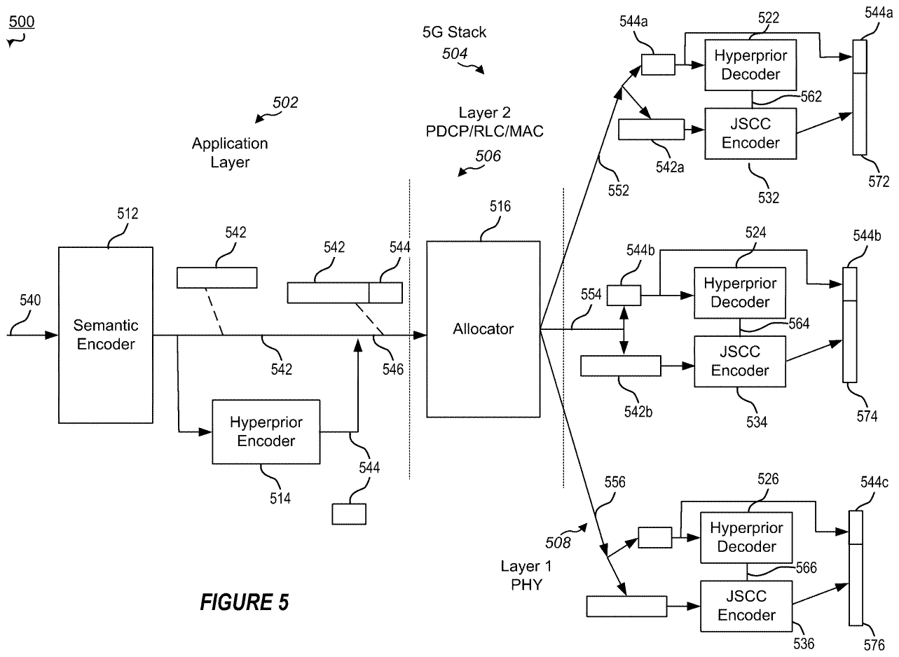

The UE 115 may further include an allocator or segmentor to allocate one or more of the type of data, 406, 408, 442, 444, into a plurality of portions thereof. Each portion of the data may correspond to a particular portion or chunk of the image of the image or video frame and may be indicated or identified by index information. The allocator or segmentor may be configured to segment the data into portions and/or combine smaller portions into other larger portions. The allocator or segmentor may include or correspond to a wireless communication stack (e.g., 5G stack) of the UE 115, as described further with reference to FIGS. 5-8. The size of the portions (e.g., allocation size) formed by the allocator may be equal than or lesser to dimensions (e.g., input dimension) associated with the JSCC and/or hyperprior coders. For example, the allocator may be configured to allocate data into portions in accordance with a size of a model of the JSCC coder 416 to ensure the JSCC coder 416 can process the portions.

In some implementations, the JSCC model may be configured to accept only certain sized image portions, such as when the allocator is position in an upper layer or the allocation operations are performed in an upper layer (e.g., prior to the physical layer). Accordingly, the allocator may be configured to segment or assemble the data to generate portions of a particular size, height, width, amount of features, or a combination thereof, based on constraints of the JSCC model. Currently, conventional systems have no such requirements, and the allocation size can be arbitrary as conventional source or channel coding have no such size limitations.

Although one UE is shown in the example of FIG. 4, in other implementation the network may include additional UEs. The other UE or UEs may include one or more elements similar to UE 115. In some implementations, the UE 115 and the other UE or UEs are different types of UEs. For example, either UE may be a higher quality or have different operating constraints. To illustrate, one of the UEs may have a larger form factor or be a current generation device, and thus have more advanced capabilities and/or reduced battery constraints, higher processing constraints, etc.

Base station 105 includes processor 430, memory 432, transmitter 434, receiver 436, encoder 437, decoder 438, semantic coder 439, JSCC coder 440, and antennas 234a-t. Processor 430 may be configured to execute instructions stores at memory 432 to perform the operations described herein. In some implementations, processor 430 includes or corresponds to controller/processor 240, and memory 432 includes or corresponds to memory 242. Memory 432 may be configured to store image data 406, semantic feature data 408, feature probability data 442, encoded image data 444, settings data, or a combination thereof, similar to the UE 115 and as further described herein.

Transmitter 434 is configured to transmit data to one or more other devices, and receiver 436 is configured to receive data from one or more other devices. For example, transmitter 434 may transmit data, and receiver 436 may receive data, via a network, such as a wired network, a wireless network, or a combination thereof. For example, UEs and/or base station 105 may be configured to transmit and/or receive data via a direct device-to-device connection, a local area network (LAN), a wide area network (WAN), a modem-to-modem connection, the Internet, intranet, extranet, cable transmission system, cellular communication network, any combination of the above, or any other communications network now known or later developed within which permits two or more electronic devices to communicate. In some implementations, transmitter 434 and receiver 436 may be replaced with a transceiver. Additionally, or alternatively, transmitter 434 or receiver, 436 may include or correspond to one or more components of UE 115 described with reference to FIG. 2.

Encoder 437, and decoder 438 may include the same functionality as described with reference to encoder 413 and decoder 414, respectively. Semantic coder 439 may include similar functionality as described with reference to semantic coder 415. JSCC coder 440 may include similar functionality as described with reference to JSCC coder 416.

During operation of wireless communications system 400, the network (e.g., base station 105) may determine that UE 115 has enhanced semantic communication capability. For example, UE 115 may transmit a message 448 that includes an enhanced semantic communication indicator 490 (e.g., an enhanced semantic encoding capability indicator). Indicator 490 may indicate semantical and JSCC encoding or decoding capability for one or more communication modes, such as uplink, downlink, sidelink, etc. In some implementations, a network entity (e.g., a base station 105) sends control information to indicate to UE 115 that enhanced semantic communication operations and/or a particular type of semantic communication operation is to be used. For example, in some implementations, configuration transmission 450 is transmitted to the UE 115. The configuration transmission 450 may include or indicate to use enhanced semantic communication operations or to adjust or implement a setting of a particular type of enhanced semantic communication operation. For example, the configuration transmission 450 may include one or more of settings information (e.g., semantic communication settings information), scheduling information, encoding model information, decoding model information, or any combination thereof. In the example, of FIG. 4, the configuration transmission 450 includes scheduling information 492. In some implementations, the scheduling information 492 includes MCS information and resource allocation information.

During operation, devices of wireless communications system 400 perform enhanced semantic communication operations. For example, the network and UEs may exchange transmissions via uplink, downlink, and/or sidelink communications over the communication links and engage in enhanced semantic communication as illustrated in the example of FIG. 4. This enhanced semantic communication enables devices to more efficiently transmit image data (e.g., image or data frames) and/or transmit larger amounts of image data (e.g., more pixels from higher resolution or larger images) in in a given physical resource. This enables reduced latency transmission of images and videos. The enhanced semantic communication operations may be achieved by encoding semantic feature data based on feature probability data and transmitting the encoded semantic feature data.

In the example of FIG. 4, the devices of the network may engage in one or more communication operations to transmit encoded semantic information, such as first transmission 452. For example, the base station 105 or the UE 115 may transmit one or more transmissions with encoded semantic information, or portions thereof. The operations of the devices of the network may cause devices of the network, such as UE 115, to engage in semantic communication of image information (e.g., image or data frames).

In the example of FIG. 4, the UE 115 generates and transmits a first transmission 452 to the base station 105. For example, the UE 115 (e.g., the semantic coder 415 thereof) encodes a first portion of the image data 406 to generate a first portion of the semantic feature data 408. The UE 115 (e.g., the JSCC coder 416 thereof) encodes the first portion of the semantic feature data 408 based on a corresponding first portion of feature probability data 442 to generate a first portion of encoded image data 444a of the encoded image data 444. The UE 115 transmits the first transmission 452, which includes the first portion of encoded image data 444a of the encoded image data 444.

In some implementations, the first transmission 452 further includes one or more portions of the encoded image data 444. For example, the first transmission 452 may include one or more additional portions of the encoded image data 444, such as a second portion of encoded image data 444b of the encoded image data 444. To illustrate, the UE 115 (e.g., the semantic coder 415 thereof) encodes a second portion of the image data 406 to generate a second portion of the semantic feature data 408, and the UE 115 (e.g., the JSCC coder 416 thereof) encodes the second portion of the semantic feature data 408 based on a corresponding second portion of feature probability data 442 to generate the second portion of encoded image data 444a of the encoded image data 444. In such implementations, the second portion of encoded image data 444a of the encoded image data 444 is included in the first transmission 452.

Additionally, or alternatively, the first transmission 452 may further include one or more portions of feature probability data 442. For example, the first transmission 452 may include one or more corresponding portions of feature probability data 442 for the portions of encoded image data 444. To illustrate, the first transmission 452 may include a corresponding first portion of feature probability data 442a of the feature probability data 442 for the first portion of encoded image data 444a of the encoded image data 444.

In addition, when the first transmission 452 further includes an additional portion or portions of encoded image data 444, the first transmission 452 may further include additional corresponding portions of feature probability data 442. For example, the first transmission 452 may include a corresponding second portion of feature probability data 442b of the feature probability data 442 for the second portion of encoded image data 444b of the encoded image data 444.

The UE 115 generates and transmits a second transmission 454 to the base station 105. For example, the UE 115 (e.g., the semantic coder 415 thereof) encodes a third portion of the image data 406 to generate a third portion of the semantic feature data 408. The UE 115 (e.g., the JSCC coder 416 thereof) encodes the third portion of the semantic feature data 408 based on a corresponding third portion of feature probability data 442 to generate a third portion of encoded image data 444c of the encoded image data 444. The UE 115 transmits the second transmission 454, which includes the third portion of encoded image data 444c of the encoded image data 444 and the third portion of feature probability data 442c of the feature probability data 442.

In some implementations, the second transmission 454 further includes one more additional portions of encoded image data 444 and/or feature probability data 442. For example, the second transmission 454 may include a fourth portion of feature probability data 442 and encoded image data. To illustrate, the UE 115 (e.g., the semantic coder 415 thereof) further encodes a fourth portion of the image data 406 to generate a fourth portion of the semantic feature data 408. The UE 115 (e.g., the JSCC coder 416 thereof) encodes the fourth portion of the semantic feature data 408 based on a corresponding fourth portion of feature probability data 442 to generate a fourth portion of encoded image data 444d of the encoded image data 444. In such implementations, the second transmission 454 further includes the fourth portion of encoded image data 444d of the encoded image data 444 and the third fourth of feature probability data 442d of the feature probability data 442.

Optionally, the UE 115 generates and transmits one or more third transmissions 456 to the base station 105. For example, the UE 115 generates additional transmissions including additional portions of the encoded image data 444 and/or the feature probability data 442.

Although FIG. 4 illustrates uplink transmission of semantically encoded image data, in other implementations, the devices are configured to transmit semantically encoded image data in other operational modes, such as downlink or sidelink. For example, the base station 105 may transmit one or more of the transmissions 452, 454, or 456 (e.g., PDSCHs) to the UE 115 or the UE 115 may transmit one or more of the transmissions 452, 454, or 456 (e.g., PSSCHs) to another UE.

In such implementations, where a transmission includes encode one or more image data portions and one or more feature probability data portions, the transmission may be generated by a concatenation of encoded image data and feature probability data. For example, a first portion of the transmission may include the one or more portions of the feature probability data. The first portion may be entropy and channel coded similar to encoding non-semantically encoded information. The second portion of the transmission may include the one or more portions of the encoded image data (e.g., JSCC encoded semantic feature data).

The transmission resources for the portions may be determined by frequency, time, and/or spatial layers. For example, a portion of the transmission, such as the first or second portion, may be a part of frequency, part of a time, or a part of layer of the transmission resources. As another example, a portion of the transmission, such as the first or second portion, may be determined by a mapping order according to frequency, time, or layers. To illustrate, the portions may be mapped to physical resources by first mapping along spatial layers, and then mapping by frequency and time. As an example, feature probability data may be mapped along spatial layers, followed by frequency and time, and then encoded image data may be mapped along spatial layers, followed by frequency and time.

Although not shown in FIG. 4, the transmissions illustrated in FIG. 4 may be signaled by additional transmissions, acknowledged by other additional transmissions, or both. For example, the base station 105 may transmit one or more control channel transmissions to schedule one or more of the transmissions 452, 454, or 456. To illustrate, the base station 105 may schedules one or more of the transmissions 452, 454, or 456 by transmitting a downlink control channel transmission, such as a PDCCH, including scheduling information for the one or more of the transmissions 452, 454, or 456. Additionally, or alternatively, a device which receives the transmissions may acknowledge the transmissions, such as the TBs thereof or the portions of encoded image data 444 thereof, by transmitting one or more control channel transmissions. To illustrate, the UE 115 when receiving encoded image data 444, may generate acknowledgement or feedback information for one or more of the transmissions 452, 454, or 456 and transmit the information in an uplink control channel transmission, such as a PUCCH. The acknowledgement or feedback information may indicate which TBs and/or portions of encoded image data 444 and/or portions of feature probability data 442 were received.

Although not shown in FIG. 4, the portions of feature probability data 442 may include or correspond to compressed or encoded portions of feature probability data 442. For example, the portions of feature probability data 442 included in the transmissions 452, 454, or 456 may correspond to compressed or encoded (e.g., compressed and encoded feature probability data or encoded compressed feature probability data of the feature probability data 442) which is compressed as compared to uncompressed feature probability data of the feature probability data 442 that is used to encode the semantic feature data 408.

Accordingly, the network (e.g., the base station 105 and the UE 115) may be able to more efficiently and effectively wirelessly transmit semantic communication or semantically communicate image information. Enhanced semantic communication of image information schemes may increase throughput and reduce latency and/or bandwidth, which may lead to better network operations. Accordingly, the network performance and experience may be increased due to the increases in speed and reductions in latency and usage.

FIG. 5 depicts an example 500 of distributed JSCC encoding for semantically encoded data. In FIG. 5, the encoding and operations may occur in one or more different portions or areas of a wireless communication device, also referred to as layers. The one or more layers may include or correspond to one or more different elements or processors of the wireless communication device. As illustrated in the example of FIG. 5, the layers include an application layer 502 and layers of a 5G stack 504, layer 2 506 and layer 1 508 (Physical layer).

In FIG. 5, the wireless communication device, such as an encoding system or processing system thereof, includes a semantic encoder 512, a hyperprior encoder 514, an allocator 516, and one or more encoding chains. Each encoding chain may include a hyperprior decoder and a JSCC encoder. As illustrated in the example of FIG. 5, three encoding chains are depicted and the wireless communication device includes a first encoding chain including a first hyperprior decoder 522 and a first JSCC encoder 532, a second encoding chain including a second hyperprior decoder 524 and a second JSCC encoder 534, and a third encoding chain including a third hyperprior decoder 526 and a third JSCC encoder 536.

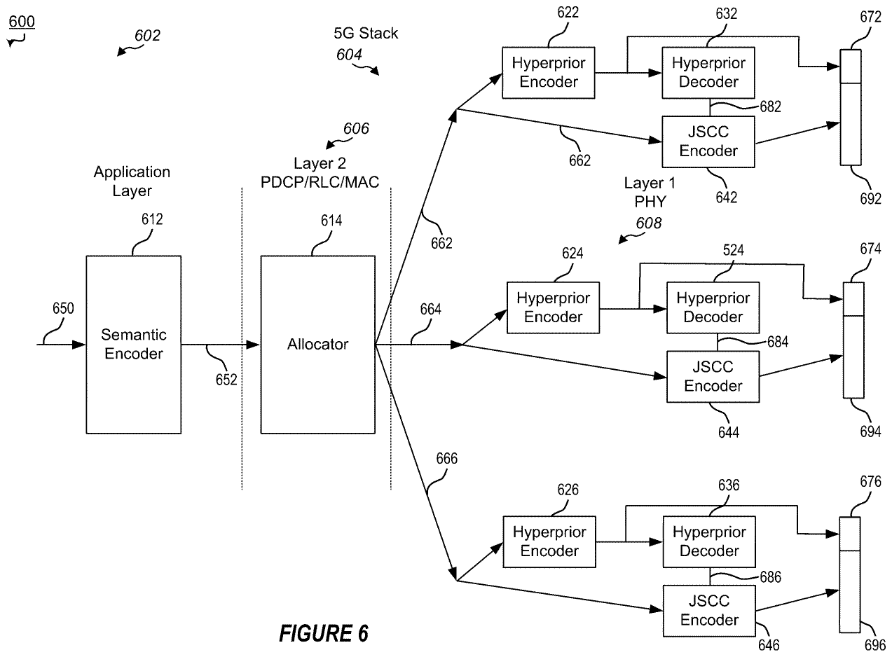

The semantic encoder 512 is configured to semantically encode image data, such as to transform received image data into semantic feature, semantic feature data. The semantic encoder may include or correspond to a semantic encoder as described with reference to FIGS. 3 and 4, or further with reference to FIG. 6.

The allocator 516 (e.g., data unit allocator) is configured to allocator or apportion received data into a plurality of portions of data. The allocator may be configured to generate index information for the generated portions. Additionally, the allocator 516 may be configure to receive first portions of data (e.g., referred to as pieces or segments) and generate second portions of data based on the first portions. The allocator 516 may be configured to perform one or more operations of segmenting and/or combining to generate intermediary portions from the first portions and then the second portions from the first and/or intermediary portions. The allocator 516 may include or correspond to data unit segmenting and concatenation operations of a 5G stack.

The hyperprior encoder 514 is configured to hyperprior encode semantic feature data such as to generate feature probability information based on semantic feature data. The hyperprior encoder 514 may include or correspond to a hyperprior encoder as described with reference to FIGS. 3 and 4, or further with reference to FIG. 6.

The hyperprior decoders are configured to hyperprior decode portions of compressed feature probability information, such as to generate portions of uncompressed or decompressed feature probability information. The hyperprior decoders may include or correspond to a hyperprior decoder as described with reference to FIGS. 3 and 4, or further with reference to FIG. 6.

The JSCC encoders are configured to encode portions of semantically encoded image data based on feature probability information, such as to generate portions of encoded image data. The JSCC encoders may include or correspond to a JSCC encoder as described with reference to FIGS. 3 and 4, or further with reference to FIG. 6.

During operation, the semantic encoder 512 receives image data 540 and generates semantic feature data 542 based on processing (semantically encoding) the image data 540. The semantic encoder 512 provides the semantic feature data 542 to the hyperprior encoder 514 and to the allocator 516.

In some implementations, the semantic encoder 512 may segment the image data 540 into chunks or portions and encode portions of the image data 540 to generate portions of the semantic feature data 542 and corresponding index information for the portions of the semantic feature data 542. The index information may indicate or identify where the portion of semantic feature data 542 belongs in the image.

The hyperprior encoder 514 receives the semantic feature data 542 and generates compressed feature probability data 544 based on processing (hyperprior encoding) the semantic feature data 542. The hyperprior encoder 514 provides the compressed feature probability data 544 to the allocator 516. For example, as illustrated in the example of FIG. 5, the semantic feature data 542 is combined with the compressed feature probability data 544. In other examples, the hyperprior encoder 514 provides the compressed feature probability data 544 to the allocator 516 separate from the semantic feature data 542.

In some implementations, the hyperprior encoder 514 may process or encode the semantic feature data 542 based on or in accordance with hyperprior encoding model information. In some implementations, the hyperprior encoding model information includes AI generated model information and the hyperprior encoder 514 may include or correspond to an AI hyperprior encoder or AI assisted hyperprior encoder. The hyperprior encoder 514 may utilize AI or machine learning techniques to process the semantic feature data 542.

The allocator 516 receives the semantic feature data 542 and the compressed feature probability data 544 and generates a plurality of portions of the semantic feature data 542 and a plurality of portions of the compressed feature probability data 544. Each portion of semantic feature data of the semantic feature data 542 may be associated with or have a corresponding portion of compressed feature probability data 544. For example, a first portion of semantic feature data, corresponding to a particular chunk of the image or video frame, may have a corresponding first portion of compressed feature probability data which indicates the probability of features for the first portion of semantic feature data and the a particular chunk of the image or video frame.

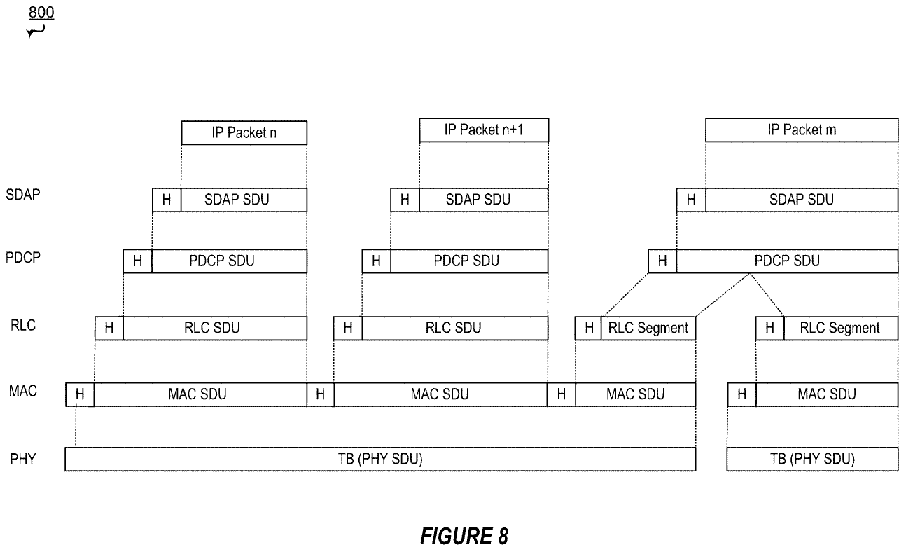

The allocator 516 may perform one or more allocation or apportionment operations on the semantic feature data 542 and the compressed feature probability data 544 to generate the plurality of portions. For example, the allocator 516 may perform one or more segmentation operation and/or one or more combination operations. To illustrate, the allocator 516 may perform one or more 5G stack or layer 2 segmentation and concatenation operations, as described further with reference to FIG. 8 to generate the plurality of portions. As an illustrative example, the semantic feature data 542 and the compressed feature probability data 544 may be segmented into first portions, and then segmented further to generate some additional second portions from the first portions, and then some of the first and/or second portions may be combined to generate third portions, etc., as the semantic feature data 542 and the compressed feature probability data 544 are processed by the 5G stack and prepared for wireless transmission.

In some implementations, the allocator 516 receives the semantic feature data 542 and the compressed feature probability data 544 in a plurality of packets, such as IP packets from the application layer 502. Each packet includes a piece or segment of the semantic feature data 542 and a corresponding piece or segment the compressed feature probability data 544, referred to as corresponding pieces 546. In such implementations, the allocator 516 allocates or appropriations received pieces of the semantic feature data 542 and the compressed feature probability data 544 into the plurality of portions of the semantic feature data 542 and the compressed feature probability data 544.

In some implementations, the allocator 516 may allocator or apportion the semantic feature data 542 and/or the compressed feature probability data 544 based on index information, such as index information received in the packet (e.g., a header thereof), based on index information generated by the allocator 516, or a combination thereof. To illustrate, the allocator 516 may receive first index information for pieces of the semantic feature data 542 and generate second index information for the plurality of portions of the semantic feature data 542 and the plurality of portions of the compressed feature probability data 544, based on the first index of information for the pieces of the semantic feature data 542.

The allocator 516 provides the portions of the semantic feature data 542 and the compressed feature probability data 544 to the one or more encoding chains. For example, the allocator 516 may provide one or more portions of the semantic feature data 542 and the compressed feature probability data 544 to each encoding chain. Each encoding chain may be associated with a transmit chain of the wireless communication device.

As illustrated in the example of FIG. 5, the allocator 516 provides a first portion of the semantic feature data 542 (first portion of semantic feature data 542a) and a first portion of the compressed feature probability data 544 (first portion of compressed feature probability data 544a) to the first encoding chain, a second portion of the semantic feature data 542 (second portion of semantic feature data 542b) and a second portion of the compressed feature probability data 544 (second portion of compressed feature probability data 544b) to the second encoding chain, and a third portion of the semantic feature data 542 (third portion of semantic feature data 542c) and a third portion of the compressed feature probability data 544 (third portion of compressed feature probability data 544c) to the third encoding chain.

The first encoding chain receives the first portion of semantic feature data 542a and the first portion of compressed feature probability data 544a as a first data pair 552. The first encoding chain provides the first portion of semantic feature data 542a to the first JSCC encoder 532 and the first portion of compressed feature probability data 544a to the first hyperprior decoder 522. In some implementations, such as when the first portion of semantic feature data 542a and the first portion of compressed feature probability data 544a are received together, the first encoding chain may split the first portion of semantic feature data 542a from the first portion of compressed feature probability data 544a and provide each component to the respective coder. To illustrate, provide the first portion of semantic feature data 542a to the first JSCC encoder 532 and the first portion of compressed feature probability data 544a to the first hyperprior decoder 522. In other implementations, the first encoding chain provides the combined data to one or more of the coders and the coder(s) separate the data need, or the first encoding chain receives the first portion of semantic feature data 542a and the first portion of compressed feature probability data 544a, separately and has two paths to provide the two separate pieces of information to the respective coder.

The first hyperprior decoder 522 receives the first portion of compressed feature probability data 544a and generates a first portion of (decompressed) feature probability data 562 based on processing (hyperprior decoding) the first portion of compressed feature probability data 544a. The first hyperprior decoder 522 provides the first portion of (decompressed) feature probability data 562 to the first JSCC encoder 532.

In some implementations, the first hyperprior decoder 522 may process or decode the first portion of compressed feature probability data 544a based on or in accordance with hyperprior decoding model information. In some implementations, the hyperprior decoding model information includes AI generated model information and the first hyperprior decoder 522 (and optionally hyperprior decoders 524 and 526) may include or correspond to an AI hyperprior decoder or AI assisted hyperprior decoder. The first hyperprior decoder 522 (and optionally hyperprior decoders 524 and 526) may utilize AI or machine learning techniques to process the portions of compressed feature probability data.

The first JSCC encoder 532 receives the first portion of semantic feature data 542a and the first portion of (decompressed) feature probability data 562, and generates a first portion of encoded semantic feature data 572 based on processing (JSCC encoding) the first portion of semantic feature data 542a in accordance with the first portion of (decompressed) feature probability data 562. The first JSCC encoder 532 provides the first portion of encoded semantic feature data 572 to transmission circuitry (e.g., a transceiver or transmit chain thereof) as encoded data for semantic communication via a first TB.

The first encoding chain provides the received first portion of compressed feature probability data 544a to the transmission circuitry (e.g., a transceiver or transmit chain thereof) for wireless communication. In some implementations, the first encoding chain further provides the first portion of compressed feature probability data 544a with the first portion of encoded semantic feature data 572 for transmission together in the first TB. In other implementations, the first portion of compressed feature probability data 544a is wirelessly transmitted separate from the first portion of encoded semantic feature data 572, such as in another TB and optionally with other portions of compressed feature probability data (e.g., 544b and/or 544c).

In some implementations, the first JSCC encoder 532 may process or encode the first portion of semantic feature data 542a using the first portion of (decompressed) feature probability data 562 based on or in accordance with JSCC encoding model information. In some implementations, the JSCC encoding model information includes AI generated model information and the first JSCC encoder 532 may include or correspond to an AI JSCC encoder or AI assisted JSCC encoder. The first JSCC encoder 532 may utilize AI or machine learning techniques to process the portions of semantic feature data.

Similarly, the second encoding chain receives the second portion of semantic feature data 542b and the second portion of compressed feature probability data 544b as a second data pair 554. The second encoding chain provides the second portion of semantic feature data 542a to the second JSCC encoder 534 and the second portion of compressed feature probability data 544b to the second hyperprior decoder 524.

The second hyperprior decoder 524 receives the second portion of compressed feature probability data 544b and generates a second portion of (decompressed) feature probability data 564 based on processing (hyperprior decoding) the second portion of compressed feature probability data 544b. The second hyperprior decoder 524 provides the second portion of (decompressed) feature probability data 564 to the second JSCC encoder 534.

The second JSCC encoder 534 receives the second portion of semantic feature data 542b and the second portion of (decompressed) feature probability data 564, and generates a second portion of encoded semantic feature data 574 based on processing (JSCC encoding) the second portion of semantic feature data 542b in accordance with the second portion of (decompressed) feature probability data 564. The second JSCC encoder 534 provides the second portion of encoded semantic feature data 574 to transmission circuitry (e.g., a transceiver or transmit chain thereof) as encoded data for semantic communication via the first TB or a second TB.

The second encoding chain provides the received second portion of compressed feature probability data 544b to the transmission circuitry (e.g., a transceiver or transmit chain thereof) for wireless communication. In some implementations, the second encoding chain further provides the second portion of compressed feature probability data 544b with the second portion of encoded semantic feature data 574 for transmission together in the first TB or the second TB. In other implementations, the second portion of compressed feature probability data 544b is wirelessly transmitted separate from the second portion of encoded semantic feature data 574, such as in another TB and optionally with other portions of compressed feature probability data (e.g., 544a and/or 544c).

Similarly, the third encoding chain receives the third portion of semantic feature data 542c and the third portion of compressed feature probability data 544c as a third data pair 556. The third encoding chain provides the third portion of semantic feature data 542c to the third JSCC encoder 536 and the third portion of compressed feature probability data 544c to the third hyperprior decoder 526.

The third hyperprior decoder 526 receives the third portion of compressed feature probability data 544c and generates a third portion of (decompressed) feature probability data 566 based on processing (hyperprior decoding) the third portion of compressed feature probability data 544c. The third hyperprior decoder 526 provides the third portion of (decompressed) feature probability data 566 to the third JSCC encoder 536.

The third JSCC encoder 536 receives the third portion of semantic feature data 542c and the third portion of (decompressed) feature probability data 566, and generates a third portion of encoded semantic feature data 576 based on processing (JSCC encoding) the third portion of semantic feature data 542c in accordance with the third portion of (decompressed) feature probability data 566. The third JSCC encoder 536 provides the third portion of encoded semantic feature data 576 to transmission circuitry (e.g., a transceiver or transmit chain thereof) as encoded data for semantic communication via the first TB, the second TB, or a third TB.

The third encoding chain provides the received third portion of compressed feature probability data 544c to the transmission circuitry (e.g., a transceiver or transmit chain thereof) for wireless communication. In some implementations, the third encoding chain further provides the third portion of compressed feature probability data 544c with the third portion of encoded semantic feature data 574 for transmission together in the first TB or the third TB. In other implementations, the third portion of compressed feature probability data 544c is wirelessly transmitted separate from the third portion of encoded semantic feature data 574, such as in another TB and optionally with other portions of compressed feature probability data (e.g., 544a and/or 544b).

Accordingly, FIG. 5 illustrates an example of distributed semantic encoding for wireless transmission of semantically encoded image information. The distributed semantic encoding of FIG. 5, may enable a wireless network to transmit semantically-encoded information in more or smaller physical resources and to enable lower processing times and latency due to semantically decoding portions of the image in parallel or at least partially concurrently.

FIG. 6 depicts another example 600 of distributed JSCC encoding for semantically encoded data. As compared to the example in FIG. 5 with hyperprior encoding performed in the application layer 502, the example of distributed JSCC encoding for semantically encoded data in FIG. 6 performs distributed hyperprior encoding in the PHY layer.

In FIG. 6, the encoding and operations may occur in one or more different portions or areas of a wireless communication device, also referred to as layers. The one or more layers may include or correspond to one or more different elements or processors of the wireless communication device. As illustrated in the example of FIG. 6, the layers include an application layer 602 and layers of a 5G stack 604, layer 2 606 and layer 1 608 (Physical layer).

In FIG. 6, the wireless communication device, such as an encoding system or processing system thereof, includes a semantic encoder 612, an allocator 614, and one or more encoding chains. Each encoding chain may include a hyperprior encoder, a hyperprior decoder, and a JSCC encoder. As illustrated in the example of FIG. 6, three encoding chains are depicted and the wireless communication device includes a first encoding chain including a first hyperprior encoder 622, a first hyperprior decoder 632, and a first JSCC encoder 642, a second encoding chain including a second hyperprior encoder 624, a second hyperprior decoder 634, and a second JSCC encoder 644, and a third encoding chain including a third hyperprior encoder 626, a third hyperprior decoder 636, and a third JSCC encoder 646.

The semantic encoder 612 is configured to semantically encode image data, such as to transform received image data into semantic feature, semantic feature data. The semantic encoder may include or correspond to a semantic encoder as described with reference to FIGS. 3-5. The allocator 614 is configured to allocator or apportion received data into a plurality of portions of data, as described with reference to allocator 516 of FIG. 5.

The hyperprior encoders are configured to hyperprior encode portions of semantic feature data, such as to generate feature probability information based on semantic feature data. The hyperprior encoders may include or correspond to a hyperprior encoder as described with reference to FIGS. 3-5.

The hyperprior decoders are configured to hyperprior decode portions of compressed feature probability information, such as to generate portions of uncompressed or decompressed feature probability information. The hyperprior decoders may include or correspond to a hyperprior decoder as described with reference to FIGS. 3-5.

The JSCC encoders are configured to encode portions of semantically encoded image data based on feature probability information, such as to generate portions of encoded image data. The JSCC encoders may include or correspond to a JSCC encoder as described with reference to FIGS. 3-5.

During operation, the semantic encoder 612 receives image data 650 and generates semantic feature data 652 based on processing (semantically encoding) the image data 650. The semantic encoder 612 provides the semantic feature data 652 to the allocator 614.

In some implementations, the semantic encoder 612 may segment the image data 650 into chunks or portions and encode portions of the image data 650 to generate portions of the semantic feature data 652 and corresponding index information for the portions of the semantic feature data 652. The index information may indicate or identify where the portion of semantic feature data 652 belongs in the image.

The allocator 614 receives the semantic feature data 652 and generates a plurality of portions of the semantic feature data 652. Each portion of semantic feature data of the semantic feature data 652 may correspond to a particular chunk of the image or video frame. For example, a first portion of semantic feature data may correspond to a first particular chunk of the image or video frame and a second portion of semantic feature data may correspond to a second particular chunk of the image or video frame.

The allocator 614 may perform one or more allocation or apportionment operations on the semantic feature data 652 to generate the plurality of portions. For example, the allocator 614 may perform one or more segmentation operation and/or one or more combination operations. To illustrate, the allocator 614 may perform one or more 5G stack or layer 2 segmentation and concatenation operations, as described further with reference to FIG. 8 to generate the plurality of portions. As an illustrative example, the semantic feature data 652 may be segmented into first portions, and then segmented further to generate some additional second portions from the first portions, and then some of the first and/or second portions may be combined to generate third portions, etc., as the semantic feature data 652 is processed by the 5G stack and prepared for wireless transmission.

In some implementations, the allocator 614 receives the semantic feature data 652 in a plurality of packets, such as IP packets from the application layer 602. In such implementations, the allocator 614 allocates or appropriations received pieces of the semantic feature data 652 into the plurality of portions of the semantic feature data 652. The allocator 614 may allocator or apportion the semantic feature data 652 based on index information, such as index information received in the packet (e.g., a header thereof), based on index information generated by the allocator 614, or a combination thereof. To illustrate, the allocator 614 may receive first index information for pieces of the semantic feature data 652 and generate second index information for the plurality of portions of the semantic feature data 652 based on the first index of information for the pieces of the semantic feature data 652.

The allocator 614 provides the portions of the semantic feature data 652 to the one or more encoding chains. For example, the allocator 614 may provide one or more portions of the semantic feature data 652 to each encoding chain. Each encoding chain may be associated with a transmit chain of the wireless communication device.

As illustrated in the example of FIG. 6, the allocator 614 provides a first portion of the semantic feature data 542 (first portion of semantic feature data 662) to the first encoding chain, a second portion of the semantic feature data 542 (second portion of semantic feature data 664) to the second encoding chain, and a third portion of the semantic feature data 542 (third portion of semantic feature data 666) to the third encoding chain.

The first encoding chain receives the first portion of semantic feature data 662, and provides the first portion of semantic feature data 662 to the first hyperprior encoder 622 and to the first JSCC encoder 642.

The first hyperprior encoder 622 receives the first portion of semantic feature data 662 and generates compressed feature probability data 672 (e.g., a first portion of compressed feature probability data) based on processing (hyperprior encoding) the first portion of semantic feature data 662. The first hyperprior encoder 622 provides the compressed feature probability data 672 to the first hyperprior decoder 632 and to transmission circuity for wireless transmission.

As illustrated in the example of FIG. 6, the device includes a plurality of hyperprior encoders, one for each chain and/or one for each hyperprior decoder. In other implementation, the device may include a single hyperprior encoder in the PHY layer (similar to the single hyperprior encoder 514 in the application layer 502 in FIG. 5) or may include a hyperprior encoder for multiple transmit chains and/or hyperprior decoders.

In some implementations, the first hyperprior encoder 622 may process or encode the first portion of semantic feature data 662 based on or in accordance with hyperprior encoding model information. In some implementations, the hyperprior encoding model information includes AI generated model information and the first hyperprior encoder 622 may include or correspond to an AI hyperprior encoder or AI assisted hyperprior encoder. The first hyperprior encoder 622 may utilize AI or machine learning techniques to process the portions of semantic feature data.

The first hyperprior decoder 632 receives the first portion of compressed feature probability data 672 and generates a first portion of (decompressed) feature probability data 682 based on processing (hyperprior decoding) the first portion of compressed feature probability data 672. The first hyperprior decoder 632 provides the first portion of (decompressed) feature probability data 682 to the first JSCC encoder 642.

In some implementations, the first hyperprior decoder 632 may process or decode the first portion of compressed feature probability data 672 based on or in accordance with hyperprior decoding model information. In some implementations, the hyperprior decoding model information includes AI generated model information and the first hyperprior decoder 632 may include or correspond to an AI hyperprior decoder or AI assisted hyperprior decoder. The first hyperprior decoder 632 may utilize AI or machine learning techniques to process the portions of compressed feature probability data.

The first JSCC encoder 642 receives the first portion of semantic feature data 662 and the first portion of (decompressed) feature probability data 682, and generates a first portion of encoded semantic feature data 692 based on processing (JSCC encoding) the first portion of semantic feature data 662 in accordance with the first portion of (decompressed) feature probability data 682. The first JSCC encoder 642 provides the first portion of encoded semantic feature data 692 to transmission circuitry (e.g., a transceiver or transmit chain thereof) as encoded data for semantic communication via a first TB.

The first hyperprior encoder 622 provides the first portion of compressed feature probability data 672 to the transmission circuitry (e.g., a transceiver or transmit chain thereof) for wireless communication via the first encoding chain. In some implementations, the first encoding chain further provides the first portion of compressed feature probability data 672 with the first portion of encoded semantic feature data 692 for transmission together in the first TB. In other implementations, the first portion of compressed feature probability data 672 is wirelessly transmitted separate from the first portion of encoded semantic feature data 692, such as in another TB and optionally with other portions of compressed feature probability data (e.g., 674 and/or 676).

In some implementations, the first JSCC encoder 642 may process or encode the first portion of semantic feature data 662 using the first portion of (decompressed) feature probability data 682 based on or in accordance with JSCC encoding model information. In some implementations, the JSCC encoding model information includes AI generated model information and the first JSCC encoder 642 may include or correspond to an AI JSCC encoder or AI assisted JSCC encoder. The first JSCC encoder 642 may utilize AI or machine learning techniques to process the portions of semantic feature data.

Similarly, the second encoding chain receives the second portion of semantic feature data 664, and provides the second portion of semantic feature data 664 to the second hyperprior encoder 624 and to the second JSCC encoder 644. The second hyperprior encoder 624 receives the second portion of semantic feature data 664 and generates compressed feature probability data 674 based on processing (hyperprior encoding) the second portion of semantic feature data 664. The second hyperprior encoder 624 provides the compressed feature probability data 674 to the second hyperprior decoder 634 and to transmission circuity for wireless transmission.

In some implementations, the second hyperprior encoder 624 may process or encode the second portion of semantic feature data 664 based on or in accordance with hyperprior encoding model information. In some implementations, the hyperprior encoding model information includes AI generated model information and the second hyperprior encoder 624 may include or correspond to an AI hyperprior encoder or AI assisted hyperprior encoder. The second hyperprior encoder 624 may utilize AI or machine learning techniques to process the portions of semantic feature data.

The second hyperprior decoder 634 receives the second portion of compressed feature probability data 674 and generates a second portion of (decompressed) feature probability data 684 based on processing (hyperprior decoding) the second portion of compressed feature probability data 674. The second hyperprior decoder 634 provides the second portion of (decompressed) feature probability data 684 to the second JSCC encoder 644.

In some implementations, the second hyperprior decoder 634 may process or decode the second portion of compressed feature probability data 674 based on or in accordance with hyperprior decoding model information. In some implementations, the hyperprior decoding model information includes AI generated model information and the second hyperprior decoder 634 may include or correspond to an AI hyperprior decoder or AI assisted hyperprior decoder. The second hyperprior decoder 634 may utilize AI or machine learning techniques to process the portions of compressed feature probability data.

The second JSCC encoder 644 receives the second portion of semantic feature data 664 and the second portion of (decompressed) feature probability data 684, and generates a second portion of encoded semantic feature data 694 based on processing (JSCC encoding) the second portion of semantic feature data 664 in accordance with the second portion of (decompressed) feature probability data 684. The second JSCC encoder 644 provides the second portion of encoded semantic feature data 694 to transmission circuitry (e.g., a transceiver or transmit chain thereof) as encoded data for semantic communication via the first TB or a second TB.

The second hyperprior encoder 624 provides the second portion of compressed feature probability data 674 to the transmission circuitry (e.g., a transceiver or transmit chain thereof) for wireless communication via the second encoding chain. In some implementations, the second encoding chain further provides the second portion of compressed feature probability data 674 with the second portion of encoded semantic feature data 694 for transmission together in the first TB or the second TB. In other implementations, the second portion of compressed feature probability data 674 is wirelessly transmitted separate from the second portion of encoded semantic feature data 694, such as in another TB and optionally with other portions of compressed feature probability data (e.g., 672 and/or 676).

In some implementations, the second JSCC encoder 644 may process or encode the second portion of semantic feature data 664 using the second portion of (decompressed) feature probability data 684 based on or in accordance with JSCC encoding model information. In some implementations, the JSCC encoding model information includes AI generated model information and the second JSCC encoder 644 may include or correspond to an AI JSCC encoder or AI assisted JSCC encoder. The second JSCC encoder 644 may utilize AI or machine learning techniques to process the portions of semantic feature data.

Similarly, the third encoding chain receives the third portion of semantic feature data 666, and provides the third portion of semantic feature data 666 to the third hyperprior encoder 626 and to the third JSCC encoder 646. The third hyperprior encoder 626 receives the third portion of semantic feature data 666 and generates compressed feature probability data 676 based on processing (hyperprior encoding) the third portion of semantic feature data 666. The third hyperprior encoder 626 provides the compressed feature probability data 676 to the third hyperprior decoder 636 and to transmission circuity for wireless transmission.

In some implementations, the third hyperprior encoder 626 may process or encode the third portion of semantic feature data 666 based on or in accordance with hyperprior encoding model information. In some implementations, the hyperprior encoding model information includes AI generated model information and the third hyperprior encoder 626 may include or correspond to an AI hyperprior encoder or AI assisted hyperprior encoder. The third hyperprior encoder 626 may utilize AI or machine learning techniques to process the portions of semantic feature data.

The third hyperprior decoder 636 receives the third portion of compressed feature probability data 676 and generates a third portion of (decompressed) feature probability data 686 based on processing (hyperprior decoding) the third portion of compressed feature probability data 676. The third hyperprior decoder 636 provides the third portion of (decompressed) feature probability data 686 to the third JSCC encoder 646.

In some implementations, the third hyperprior decoder 636 may process or decode the third portion of compressed feature probability data 676 based on or in accordance with hyperprior decoding model information. In some implementations, the hyperprior decoding model information includes AI generated model information and the third hyperprior decoder 636 may include or correspond to an AI hyperprior decoder or AI assisted hyperprior decoder. The third hyperprior decoder 636 may utilize AI or machine learning techniques to process the portions of compressed feature probability data.

The third JSCC encoder 646 receives the third portion of semantic feature data 666 and the third portion of (decompressed) feature probability data 686, and generates a third portion of encoded semantic feature data 696 based on processing (JSCC encoding) the third portion of semantic feature data 666 in accordance with the third portion of (decompressed) feature probability data 686. The third JSCC encoder 646 provides the third portion of encoded semantic feature data 696 to transmission circuitry (e.g., a transceiver or transmit chain thereof) as encoded data for semantic communication via the first TB, the second TB, or a third TB.

The third hyperprior encoder 626 provides the third portion of compressed feature probability data 676 to the transmission circuitry (e.g., a transceiver or transmit chain thereof) for wireless communication via the third encoding chain. In some implementations, the third encoding chain further provides the third portion of compressed feature probability data 676 with the third portion of encoded semantic feature data 696 for transmission together in the first TB or the third TB. In other implementations, the third portion of compressed feature probability data 676 is wirelessly transmitted separate from the third portion of encoded semantic feature data 696, such as in another TB and optionally with other portions of compressed feature probability data (e.g., 672 and/or 674).

In some implementations, the third JSCC encoder 646 may process or encode the third portion of semantic feature data 666 using the third portion of (decompressed) feature probability data 686 based on or in accordance with JSCC encoding model information. In some implementations, the JSCC encoding model information includes AI generated model information and the third JSCC encoder 646 may include or correspond to an AI JSCC encoder or AI assisted JSCC encoder. The third JSCC encoder 646 may utilize AI or machine learning techniques to process the portions of semantic feature data.

Accordingly, FIG. 6 illustrates an example of distributed semantic encoding for wireless transmission of semantically encoded image information. The distributed semantic encoding of FIG. 6, may enable a wireless network to transmit semantically-encoded information in more or smaller physical resources and to enable lower processing times and latency due to semantically decoding portions of the image in parallel or at least partially concurrently. As compared to FIG. 5, the processing at the physical layer 608 is increased, but the layer 2 606 allocations operations are simplified as only semantic feature data information is segmented and/or combined.

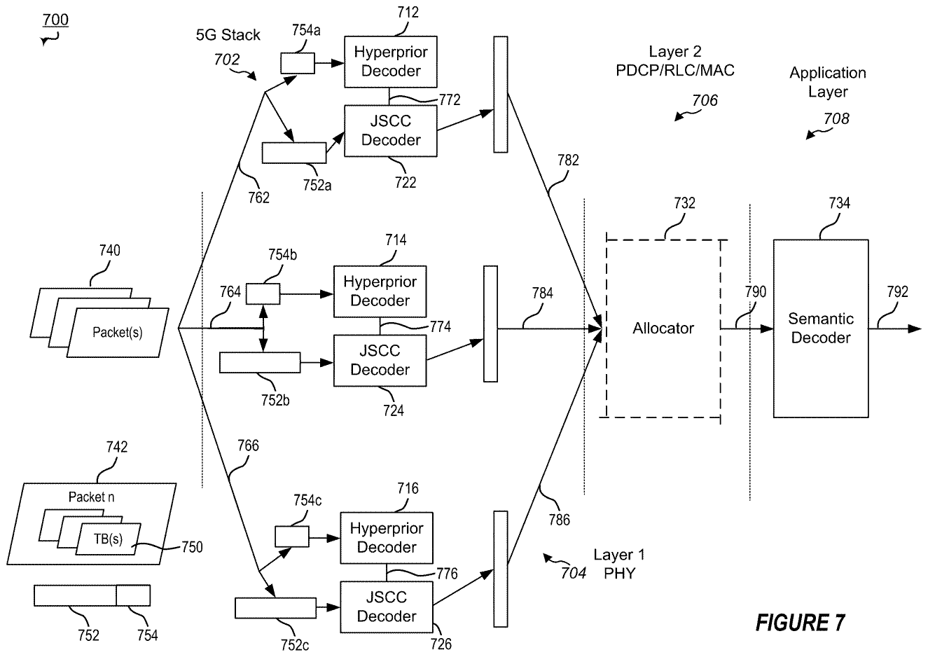

FIG. 7 depicts an example 700 of distributed JSCC decoding for semantically encoded data. In FIG. 7, the encoding and operations may occur in one or more different portions or areas of a wireless communication device, also referred to as layers. The one or more layers may include or correspond to one or more different elements or processors of the wireless communication device. As illustrated in the example of FIG. 7, the layers include layers of a 5G stack 702, layer 2 704 and layer 1 706 (Physical layer), and an application layer 708.

In FIG. 7, the wireless communication device, such as an decoding system or processing system thereof, includes one or more decoding chains and a semantic decoder 734. Each decoding chain may include a hyperprior decoder and a JSCC decoder. As illustrated in the example of FIG. 7, three decoding chains are depicted and the wireless communication device includes a first decoding chain including a first hyperprior decoder 712 and a first JSCC decoder 722, a second decoding chain including a second hyperprior decoder 714 and a second JSCC decoder 724, and a third decoding chain including a third hyperprior decoder 716 and a third JSCC decoder 726.

The wireless communication device may optionally include an allocator 732. As shown in the example of FIG. 7, the allocator 732 is coupled between the decoding chains and the semantic decoder 734. In other implementations, the allocator may be coupled to an output of the semantic decoder or to outputs of multiple semantic decoders.

Additionally, or alternatively, in some implementations, the wireless communication device may further include a segmentor. For example, the wireless communication device may include a segmentor like the segmentor 614 of FIG. 6. The segmentor may be coupled to an output of the semantic decoder and configured to segment the image data for transfer to another layer. For example, the segmentor may include or correspond to a packetizer or 5G stack configured to generate IP packets based on the decoded image data (or portions thereof).

The hyperprior decoders are configured to hyperprior decode portions of compressed feature probability information, such as to generate portions of uncompressed or decompressed feature probability information. The hyperprior decoders may include or correspond to a hyperprior decoder as described with reference to FIGS. 3-6.

The JSCC decoders are configured to decode portions of encoded image data based on feature probability information, such as to generate portions of decoded semantic feature data (semantically encoded image data). The JSCC decoders may include or correspond to a JSCC decoders as described with reference to FIGS. 3 and 4.

The allocator 732 is configured to allocator or apportion received data into a plurality of portions of data, as described with reference to allocator 516 of v 5 or 614 of FIG. 4. The semantic decoder 734 is configured to semantically decode semantically encoded image data, such as to transform received semantic feature data back into image data. The semantic decoder 734 may include or correspond to a semantic decoder as described with reference to FIGS. 3 and 4.

During operation, the wireless communication device receives one or more packets 740. Each packet 742 of the one or more packets 740 may include one or more TBs 750, and the one or more TBs may include encoded semantic feature data 752 and compressed feature probability data 754. The encoded semantic feature data 752 and compressed feature probability data 754 may include or correspond to one or more portions of encoded semantic feature data and compressed feature probability data for an image or video frame, such as the portions of encoded semantic feature data and compressed feature probability data described in FIGS. 4-6.

Receive circuitry (e.g., a transceiver) of the wireless communication device provides encoded semantic feature data 752 and compressed feature probability data 754 to one more decoding chains. As illustrated in the example of FIG. 7, the receive circuitry provides a first portion of the encoded semantic feature data 752 (first portion of encoded semantic feature data 752a) and a first portion of the compressed feature probability data 754 (first portion of compressed feature probability data 754a) to the first decoding chain, a second portion of the encoded semantic feature data 752 (second portion of encoded semantic feature data 752b) and a second portion of the compressed feature probability data 754 (second portion of compressed feature probability data 754b) to the second decoding chain, and a third portion of the encoded semantic feature data 752 (third portion of encoded semantic feature data 752c) and a third portion of the compressed feature probability data 754 (third portion of compressed feature probability data 754c) to the third decoding chain.

Each receive chain generally reverses the JSCC encoding and semantic encoding described with reference in FIGS. 4-6. The first decoding chain receives a first TB 762 or portion thereof) including the first portion of encoded semantic feature data 752a and the first portion of compressed feature probability data 754a. The first decoding chain provides the first portion of encoded semantic feature data 752a to the first JSCC decoder 722 and the first portion of compressed feature probability data 754a to the first hyperprior decoder 712.

The first hyperprior decoder 712 receives the first portion of compressed feature probability data 754a and generates a first portion of (decompressed) feature probability data 772 based on processing (hyperprior decoding) the first portion of compressed feature probability data 754a. The first hyperprior decoder 712 provides the first portion of (decompressed) feature probability data 772 to the first JSCC decoder 722.

The first JSCC decoder 722 receives the first portion of encoded semantic feature data 752a and the first portion of (decompressed) feature probability data 772, and generates a first portion of semantic feature data 782 based on processing (JSCC decoding) the first portion of encoded semantic feature data 752a in accordance with the first portion of (decompressed) feature probability data 772. The first JSCC decoder 722 provides the first portion of (decoded) semantic feature data 782 to the semantic decoder 734. As illustrated in the example of FIG. 8, the first JSCC decoder 722 provides the first portion of (decoded) semantic feature data 782 to the allocator 732, which provides allocated or combined (decoded) semantic feature data to the semantic decoder 734.

The second decoding chain receives a second TB 764 (or a portion of the first TB 762) including the second portion of encoded semantic feature data 752b and the second portion of compressed feature probability data 754b. The second decoding chain provides the second portion of encoded semantic feature data 752b to the second JSCC decoder 724 and the second portion of compressed feature probability data 754b to the second hyperprior decoder 714.

The second hyperprior decoder 714 receives the second portion of compressed feature probability data 754b and generates a second portion of (decompressed) feature probability data 774 based on processing (hyperprior decoding) the second portion of compressed feature probability data 754b. The second hyperprior decoder 714 provides the second portion of (decompressed) feature probability data 774 to the second JSCC decoder 724.

The second JSCC decoder 724 receives the second portion of encoded semantic feature data 752b and the second portion of (decompressed) feature probability data 772, and generates a second portion of semantic feature data 784 based on processing (JSCC decoding) the second portion of encoded semantic feature data 752b in accordance with the second portion of (decompressed) feature probability data 774. The second JSCC decoder 724 provides the second portion of (decoded) semantic feature data 784 to the semantic decoder 734. As illustrated in the example of FIG. 8, the second JSCC decoder 724 provides the second portion of (decoded) semantic feature data 784 to the allocator 732, which provides allocated or combined (decoded) semantic feature data to the semantic decoder 734.

The third decoding chain receives a third TB 766 (or a portion of the first or second TBs) including the third portion of encoded semantic feature data 752c and the third portion of compressed feature probability data 754c. The third decoding chain provides the third portion of encoded semantic feature data 752c to the third JSCC decoder 726 and the third portion of compressed feature probability data 754c to the third hyperprior decoder 716.

The third hyperprior decoder 716 receives the third portion of compressed feature probability data 754c and generates a third portion of (decompressed) feature probability data 776 based on processing (hyperprior decoding) the third portion of compressed feature probability data 754c. The third hyperprior decoder 716 provides the third portion of (decompressed) feature probability data 776 to the third JSCC decoder 726.

The third JSCC decoder 726 receives the third portion of encoded semantic feature data 752c and the third portion of (decompressed) feature probability data 776, and generates a third portion of semantic feature data 786 based on processing (JSCC decoding) the third portion of encoded semantic feature data 752c in accordance with the third portion of (decompressed) feature probability data 776. The third JSCC decoder 726 provides the third portion of (decoded) semantic feature data 786 to the semantic decoder 734. As illustrated in the example of FIG. 8, the third JSCC decoder 726 provides the third portion of (decoded) semantic feature data 782 to the allocator 732, which provides allocated or combined (decoded) semantic feature data to the semantic decoder 734.

The allocator 732 receives decoded semantic feature data and combined semantic feature data based on combining or concatenating one or more pieces of semantic feature data. The allocator 732 may be configured to combine the semantic feature data based on index information. For example, the allocator 732 may be configured to order or rearranged portions of semantic feature data to generate combined semantic feature data.

In the example of FIG. 7, the allocator 732 receives the three portions of semantic feature data 782-786, and generates combined (decoded) semantic feature data 790 based on the three portions of semantic feature data 782-786. The allocator 732 provides the combined semantic feature data 790 to the semantic decoder 734 for semantic decoding.

The semantic decoder 734 receives decoded semantic feature data and generates image data based on processing (semantically decoding) the semantic feature data. The semantic decoder 734 semantically transforms the feature information back to image information.

In the example of FIG. 7, the semantic decoder 734 receives the combined (decoded) semantic feature data 790 and generates image data 792 based on processing (semantically decoding) the combined (decoded) semantic feature data 790. The semantic decoder 734 provides the image data 792 to another element of a wireless communication device, such as for storage or display or an image corresponding to the image data 792.

In other implementations, the semantic decoder 734 may receive portions of the (decoded) semantic feature data and semantically decode each portion of (decoded) semantic feature data. Additionally, in some such implementations the device may include multiple semantic decoders, and each semantic decoder may semantically decode a received portion of the semantic feature data. For example, each receive chain or group of receive chains may have a semantic decoder. In some such implementations, the semantic decoders may provide the portions of decoded image data to an allocator (e.g., allocator 732) which is configured to combine the portions of decoded image data. In some implementations, one or more of the decoders (e.g., hyperprior, JSCC, semantic, etc.) of the example of FIG. 7 may utilize AI or ML model information to perform the processing or decoding operations, as described with reference to FIGS. 4-7.

Accordingly, FIG. 7 illustrates an example of distributed semantic decoding for wireless transmission of semantically encoded image information. The distributed semantic decoding of FIG. 7, may enable a wireless network to transmit semantically-encoded information in more or smaller physical resources and to enable lower processing times and latency due to semantically decoding portions of the image in parallel or at least partially concurrently.

FIG. 8 depicts an example of 5G data unit allocation operations. In FIG. 8, service data unit (SDU) and protocol data unit (PDU) flow is illustrated as packet information flows through a 5G stack 800 for transmission of information. As used herein, allocation operations include segmentation operations (e.g., dividing or apportioning a larger quantity of data into multiple smaller units or quantities), assembly operations (e.g., combining or concatenating multiple smaller units or quantities into one or more larger units or quantities), or a combination thereof. The operations of FIG. 8, may be performed by an allocator or segmentor as described with reference to FIGS. 4-7.

FIG. 8 depicts a plurality of layers of the 5G stack 800, a service data application protocol (SDAP) layer, a packet data convergence protocol (PDCP) layer, a radio link control (RLC) layer, a medium access control (MAC) layer, and a physical (PHY) layer. The 5G stack (e.g., modem or transceiver processing system) may receive information from other higher layers, such as the application layer in a plurality of IP packets, and allocate the received data into data units for 5G stack processing.

Each layer may be configured to receive information from another layer (a PDU) as an SDU, process the SDU, generate header information for the SDU and append the header information to the SDU, generate a PDU based on the processed SDU and header information and provide the PDU to a next layer (e.g., lower layer in the example of FIG. 8) which is received as an SDU of the next layer. Additionally, one or more of the layers may be configured to adjust a size of a received SDU by generating a PDU based on two or more received SDUs (concatenation) or by generating two or more PDUs based on a received SDU (segmentation). Accordingly, in this manner the 5G stack may generate a plurality of TBs which include the information of one or more packets, including only partial information from the one or more packets. The 5G stack may utilize packet index information and additional index information for the data units to keep track or portions of the semantically encoded image information (semantic feature data), portions of the feature probability information (compressed feature probability data), or both.

During operation, the SDAP layer receives a plurality of IP packets from another layer, such as an application layer. As illustrated in the example of FIG. 8, the SDAP receives three IP packets. The three IP packets may include index information, such as index information for a chunk or segment of an image or video frame.

The three IP packets correspond to, or when received at the SDAP layer correspond to, SDAP SDUs. The SDAP layer performs SDAP processing or layer operations and generates three corresponding SDAP PDUs based on the three SDAP SDUs and corresponding header information. The three SDAP PDUs are provided to the PDCP layer.

The PDCP layer receives the three SDAP PDUs as PDCP SDUs and performs PDCP processing or layer operations. The PDCP layer generates three corresponding PDCP PDUs based on the three PDCP SDUs and corresponding header information.

The RLC layer receives the three PDCP PDUs as RLC SDUs and performs RLC processing or layer operations and generates corresponding RLC PDUs based on the received RLC SDUs and corresponding header information. For example, the RLC layer performs a segmentation operation on the third PDCP PDU to generate two RLC segments based on the third PDCP PDU, first RLC SDU segment and a second RLC SDU segment. The RLC layer generates a third RLC PDU and a fourth RLC PDU based on the RLC SDU segments generated based on the third PDCP PDU. The RLC layer may generate index information indicating or identifying the portions of data split up (e.g., portion X of semantic feature data was split into Xa and Xb).

The MAC layer receives the RLC PDUs as MAC SDUs and performs MAC processing or layer operations and generates corresponding MAC PDUs based on the MAC SDUs and corresponding header information. In the example of FIG. 8, the MAC layer generates two MAC PDUs based on the four received MAC SDUs and corresponding header information. The two MAC PDUs are provided to the PHY layer. For example, the MAC layer performs an assembly operation (e.g., combine or concatenate operation) on the first, second and third MAC SDUs to generate a single MAC PDU, first MAC PDU. The MAC layer may generate index information indicating or identifying the portions of data combined together (e.g., portions A, B, and C of semantic feature data were combined to form ABC or D).

The PHY layer receives the MAC PDUs as PHY SDUs and may perform one or more PHY operations or PHY processing. For example, the PHY layer may perform the encoding or decoding operations described in FIGS. 4-7. To illustrate, the PHY layer performs the JSCC encoding (or decoding) and hyperprior decoding in some implementations. Optionally, the PHY layer performs the hyperprior encoding. Additionally, the PHY layer may perform semantic encoding in other operations.

The PHY SDUs may include or correspond to TBs, or the PHY layer generates TBs based on the received MAC PDUs. The TBs generated by the 5G stack may include one or more portions of semantic feature data, one or more corresponding portions of feature probability data, or a combination thereof. The TBs may further include index information for the portions of data included therein, such as packet index information and 5G stack segmentation or allocation index information.

Although FIG. 8 illustrates an example of allocation operations for transmission of semantic information, a 5G stack of a receiving device may reverse the allocation operations of the transmitting 5G stack, 5G stack 800. For example, the RLC layer of the 5G stack of the receiving device may combine or concatenate the two RLC segments to generate a single RLC data unit to reverse the RLC segmentation at the transmitting device.

In some implementations, image index information or mapping information of which segment correspond to which image chunk is only known to an application layer. In such implementations, this image index information is transparent to and/or separate from 5G segmentation. At a transmitting device, the 5G stack 800 may perform one or more allocation operations at one or more of the layers, and include information, such as in a header thereof, for a 5G stack at a receiving device to reverse the operations such that when the 5G stack of the receiving device generates the IP packets, the IP packets correspond to the IP packets received at the 5G stack 800 of the transmitting device. For example, at the receiving device performs the reverse operations layer-by-layer in reverse order of the transmitting device and provides the recovered IP packets to the application layer.

Accordingly, FIG. 8 illustrates an example of allocation operations for portions of data in semantic communication. The allocation operations of FIG. 8, may enable a wireless communication device to allocate received data or portions thereof into other portions for distributed encoding or decoding to enable distributed semantic encoding and decoding for sematic communication as depicted in FIGS. 5-7.

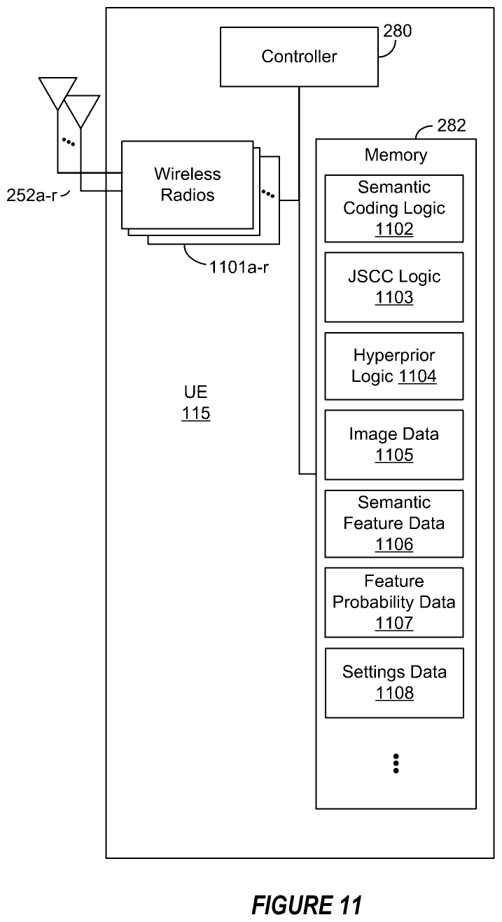

FIG. 9 is a flow diagram 900 illustrating example blocks executed by a wireless communication device (e.g., a UE or base station) configured according to an aspect of the present disclosure. The example blocks will also be described with respect to UE 115 as illustrated in FIG. 11. FIG. 11 is a block diagram illustrating UE 115 configured according to one aspect of the present disclosure. UE 115 includes the structure, hardware, and components as illustrated for UE 115 of FIGS. 2 and/or 4. For example, UE 115 includes controller/processor 280, which operates to execute logic or computer instructions stored in memory 282, as well as controlling the components of UE 115 that provide the features and functionality of UE 115. UE 115, under control of controller/processor 280, transmits and receives signals via wireless radios 1101a-r and antennas 252a-r. Wireless radios 1101a-r includes various components and hardware, as illustrated in FIG. 2 for UE 115, including modulator/demodulators 254a-r, MIMO detector 256, receive processor 258, transmit processor 264, and TX MIMO processor 266. As illustrated in the example of FIG. 11, memory 282 stores semantic coding logic 1102, JSCC logic 1103, hyperprior logic 1104, image data 1105, semantic feature data 1106, feature probability data 1107, and settings data 1108. The data (1102-1108) stored in the memory 282 may include or correspond to the data (406, 408, 442, and/or 444) stored in the memory 404 of FIG. 4. The settings data 1108 may include coding model information, such as AI generated coding model information for one or more of the semantic coding logic 1102, the JSCC logic 1103, or the hyperprior logic 1104.

At block 902, a wireless communication device, such as a UE or base station, apportions semantic feature data associated with a semantically-encoded image or video frame into a plurality of portions in accordance with a MCS and a resource allocation. The semantic feature data may include or correspond to one or more of the semantic feature data 334 of FIG. 3, the semantic feature data 408 of FIG. 4, the semantic feature data 542 of FIG. 5, the semantic feature data 652 of FIG. 6, or one or more of the PDUs of FIG. 8. The plurality of portions of the semantic feature data may include or correspond to portions of semantic feature data 408 which are encoded to generate one or more portions of encoded semantic feature data 444a-444f of FIG. 4, the portions of semantic feature data 542a-542c of FIG. 5, the portions of semantic feature data 662-666 of FIG. 6, or data of one or more of the data units of FIG. 8. The MCS and the resource allocation may include or correspond to 492. For example, the wireless communication device (e.g., UE 115 or base station 105) may apportion the semantic feature data 408 into a plurality of portions of semantic feature data, which are encoded to generate the encoded portions 444a-444d, as described with reference to FIG. 4. As other examples, the wireless communication device apportion the semantic feature data 542 into a plurality of portions of semantic feature data 542a-542c as described with reference to FIG. 5 or may apportion the semantic feature data 652 into a plurality of portions of semantic feature data 662-666 as described with reference to FIG. 6.

At block 904, the wireless communication device hyperprior decodes compressed feature probability data associated with the semantic feature data. The compressed feature probability data may include or correspond to one or more of the feature probability data 442 of FIG. 4, the portions of compressed feature probability data 442a-442d of FIG. 4, the compressed feature probability data 544 of FIG. 5, the portions of compressed feature probability data 544a-544c of FIG. 5, the portions of compressed feature probability data 672-676 of FIG. 6, the compressed feature probability data 754 of FIG. 7, the portions of compressed feature probability data 754a-754c of FIG. 7, or data of one or more of the data units of FIG. 8. For example, the wireless communication device may hyperprior decode compressed feature probability data, as in FIG. 3, may hyperprior decode portions of compressed feature probability data of the compressed feature probability data 442 as in FIG. 4, or may hyperprior decode portions of compressed feature probability data as described with reference to FIGS. 5 and 6.

At block 906, the wireless communication device encodes each portion of the plurality of portions of the semantic feature data in association with a respective portion of a plurality of portions of the decoded feature probability data. The decoded feature probability data may include or correspond to one or more of the feature probability data 442 of FIG. 4, portions of decoded feature probability data which correspond to the portions of compressed and/or encoded feature probability data 442a-442d of FIG. 4, the portions of decoded feature probability data 562-566 of FIG. 5, the portions of decoded feature probability data 682-686 of FIG. 6, or the portions of decoded feature probability data 772-776 of FIG. 7. The respective portion of the decoded feature probability data may include or correspond to a portion of the decoded feature probability data that corresponds to a same segment or chunk of the image as its corresponding semantic feature data. For example, the wireless communication device may JSCC encode semantic feature data as in FIG. 3, may JSCC encode portions of semantic feature data 408 as in FIG. 4, or may JSCC encode portions of semantic feature data as described with reference to FIGS. 5 and 6. The encoding or JSCC encoding is performed in association with the decoded feature probability data, such as based on or in accordance with the decoded feature probability data.

At block 908, the wireless communication device transmits a TB that includes one or more of the encoded portions of the semantic feature data. The TB may include or correspond to one or more TBs of the data transmissions of FIG. 4, such the first transmission 452, the second transmission 454, or the third transmission(s) 456, or a TB as described with reference to any of FIGS. 5-8. The one or more of the encoded portions of the semantic feature data may include or correspond to one or more of the encoded image data 444 of FIG. 4, one or more portions of the encoded image data 444a-444d of FIG. 4, the portions of encoded semantic feature data 572-574 of FIG. 5, the portions of encoded semantic feature data 692-696 of FIG. 6, or the encoded semantic feature data 752 of FIG. 7, the portions of encoded semantic feature data 752a-752c of FIG. 7, or data of one or more data units of FIG. 8. For example, the wireless communication device may transmit one or more of the encoded portions of the semantic feature data to another device in a PUSCH, PDSCH, or PSSCH. To illustrate, a transmitter (e.g., transmit processor 264 or transmitter 410) of the UE 115 transmits the first transmission 452 via wireless radios 1101a-r and antennas 252a-r including at least the first portion of encoded image data 444a.

The wireless communication device (e.g., UE or base station) may execute additional blocks (or the wireless communication device may be configured further perform additional operations) in other implementations. For example, the wireless communication device (e.g., the UE 115) may perform one or more operations described above, such as described with reference to FIGS. 3-8. As another example, the wireless communication device (e.g., the UE 115 or base station 105, such as a processing system thereof) may perform one or more aspects as presented below.

In a first aspect, to receive the semantic feature data, the processing system is configured to cause the wireless communication device to: receive a plurality of packets including the semantic feature data, each packet including a respective portion of semantic feature data of the semantic feature data and corresponding index information for the respective portion of semantic feature data.

In a second aspect, alone or in combination with the first aspect, the processing system is further configured to cause the wireless communication device to: receive the compressed feature probability data with the semantic feature data in a plurality of packets; or generate the compressed feature probability data in association with encoding the semantic feature data.

In a third aspect, alone or in combination with one or more of the above aspects, the processing system is further configured to cause the wireless communication device to: semantically encode raw image data of the image or video frame to generate the semantic feature data; and hyperprior encode the semantic feature data to generate the compressed feature probability data.

In a fourth aspect, alone or in combination with one or more of the above aspects, to semantically encode the raw image data, the processing system is configured to cause the wireless communication device to: transform the raw image data in an image dimension, having a height, a width, and a number of color channels, to the semantic feature data in a feature space dimension, having a height, a width, and a weight, in association with semantic encoding model information, wherein the feature space dimension has a reduced value for the height and the width as compared to a corresponding value for the height and the width of the image dimension, and has an increased value for the weight as compared to a corresponding value of the color channel of the image dimension.

In a fifth aspect, alone or in combination with one or more of the above aspects, the processing system is further configured to cause the wireless communication device to: hyperprior encode the semantic feature data to generate the compressed feature probability data prior to the apportionment of the semantic feature data in association with hyperprior encoding model information.

In a sixth aspect, alone or in combination with one or more of the above aspects, to hyperprior encode the semantic feature data, the processing system is configured to cause the wireless communication device to: identify features of the semantic feature data in association with the hyperprior encoding model information; determine a probability for each feature of the semantic feature data in association with the hyperprior encoding model information; and output the compressed feature probability data indicating the probability for each feature of the semantic feature data in an encoded format.

In a seventh aspect, alone or in combination with one or more of the above aspects, to apportion the semantic feature data into the plurality of portions of the semantic feature data, the processing system is configured to cause the wireless communication device to: segment the semantic feature data into the plurality of portions of the semantic feature data; and segment the compressed feature probability data into a plurality of respective portions, wherein the processing system is further configured to cause the wireless communication device to: transfer one or more portions of the semantic feature data and one or more respective portions of the compressed feature probability data to a physical layer in a medium access control (MAC) protocol data unit (PDU).

In an eighth aspect, alone or in combination with one or more of the above aspects, the processing system is further configured to cause the wireless communication device to: receive the compressed feature probability data; and segment the compressed feature probability data into a plurality of portions, each portion of the compressed feature probability data representing a respective portion of an image represented by the image or video frame and associated with a respective portion of the semantic feature data of the plurality of portions of the semantic feature data.

In a ninth aspect, alone or in combination with one or more of the above aspects, the processing system is further configured to cause the wireless communication device to hyperprior encode each portion of the plurality of portions of the semantic feature data to generate a respective portion of the compressed feature probability data in association with hyperprior encoding model information; and to hyperprior decode the compressed feature probability data, the processing system is configured to cause the wireless communication device to hyperprior decode each portion of the compressed feature probability data to generate the respective portion of the plurality of portions of the decoded feature probability data in association with hyperprior decoding model information.

In a tenth aspect, alone or in combination with one or more of the above aspects, the hyperprior encoding and the hyperprior decoding occurs at a physical layer using a plurality of hyperprior encoders and a plurality of hyperprior decoders, wherein each hyperprior encoder is associated with a respective hyperprior decoder.

In an eleventh aspect, alone or in combination with one or more of the above aspects, to hyperprior decode the compressed feature probability data, the processing system is configured to cause the wireless communication device to: uncompress the compressed feature probability data in association with hyperprior decoding model information.

In a twelfth aspect, alone or in combination with one or more of the above aspects, to apportion the semantic feature data into the plurality of portions of the semantic feature data, the processing system is configured to cause the wireless communication device to: generate the plurality of portions of the semantic feature data based on received pieces of the semantic feature data from a plurality of packets.

In a thirteenth aspect, alone or in combination with one or more of the above aspects, to apportion the semantic feature data into the plurality of portions of the semantic feature data, the processing system is configured to cause the wireless communication device to: segment the semantic feature data into the plurality of portions of the semantic feature data; segment the compressed feature probability data into a plurality of respective portions of compressed feature probability data; assign one or more portions of the semantic feature data and the respective one or more portions of the compressed feature probability data to a service data adaption protocol (SDAP) service data unit (SDU); and generate one or more packet data convergence protocol (PDCP) SDUs based on the SDAP SDU and SDAP header information.

In a fourteenth aspect, alone or in combination with one or more of the above aspects, to apportion the semantic feature data into the plurality of portions of the semantic feature data, the processing system is configured to cause the wireless communication device to: segment the semantic feature data into the plurality of portions of the semantic feature data; segment the compressed feature probability data into a plurality of respective portions of compressed feature probability data; assign one or more portions of the semantic feature data and the respective one or more portions of the compressed feature probability data to a packet data convergence protocol (PDCP) service data unit (SDU); and generate one or more radio link control (RLC) SDUs based on the PDCP SDU and PDCP header information.

In a fifteenth aspect, alone or in combination with one or more of the above aspects, to apportion the semantic feature data into the plurality of portions of the semantic feature data, the processing system is configured to cause the wireless communication device to: segment the semantic feature data into the plurality of portions of the semantic feature data; segment the compressed feature probability data into a plurality of respective portions of compressed feature probability data; assign one or more portions of the semantic feature data and the respective one or more portions of the compressed feature probability data to a radio link control (RLC) service data unit (SDU); and generate one or more medium access control (MAC) SDUs based on the RLC SDU and RLC header information.

In a sixteenth aspect, alone or in combination with one or more of the above aspects, the processing system is further configured to cause the wireless communication device to: generate the TB based on at least one MAC SDU of the one or more MAC SDUs, wherein to generate the TB, the processing system is configured to cause the wireless communication device to joint source-channel coding (JSCC) encode a particular portion of the semantic feature data of the plurality of portions of semantic feature of the at least one MAC SDU to generate a particular encoded portion of the one or more encoded portions of the semantic feature data.

In a seventeenth aspect, alone or in combination with one or more of the above aspects, to apportion the semantic feature data into the plurality of portions of the semantic feature data, the processing system is configured to cause the wireless communication device to: segment the semantic feature data into the plurality of portions of the semantic feature data; segment the compressed feature probability data into a plurality of respective portions of compressed feature probability data; assign one or more portions of the semantic feature data and the respective one or more portions of the compressed feature probability data to a radio link control (RLC) service data unit (SDU); and generate one or more medium access control (MAC) SDUs based on the RLC SDU and RLC header information.

In an eighteenth aspect, alone or in combination with one or more of the above aspects, the processing system is further configured to cause the wireless communication device to: generate the TB based on at least one MAC SDU of the one or more MAC SDUs, wherein to generate the TB, the processing system is configured to cause the wireless communication device to joint source-channel coding (JSCC) encode a particular portion of the semantic feature data of the plurality of portions of semantic feature of the at least one MAC SDU to generate a particular encoded portion of the one or more encoded portions of the semantic feature data.

In a nineteenth aspect, alone or in combination with one or more of the above aspects, the TB further includes one or more portions of the compressed feature probability data corresponding to the one or more encoded portions of the semantic feature data; and the processing system is configured to cause the wireless communication device to transmit a plurality of TBs, including the TB, each TB of the plurality of TBs including one or more second encoded portions of the semantic feature data and one or more second portions of second compressed feature probability data corresponding to the one or more second encoded portions of the semantic feature data.

In a twentieth aspect, alone or in combination with one or more of the above aspects, the one or more portions of the compressed feature probability data comprise encoded compressed feature probability data, and wherein the processing system is further configured to cause the wireless communication device to: entropy encode the one or more corresponding portions of the compressed feature probability data to generate one or more corresponding portions of partially-encoded compressed feature probability data; and channel encode the one or more corresponding portions of the partially-encoded compressed feature probability data to generate the one or more corresponding portions of the encoded compressed feature probability data.

In a twenty-first aspect, alone or in combination with one or more of the above aspects, to apportion the semantic feature data into the plurality of portions of the semantic feature data, the processing system is configured to cause the wireless communication device to: perform one or more segmentation operations on first pieces of the semantic feature data to generate second pieces of the semantic feature data; and perform one or more assembly operations (e.g., combine or concatenate) on third pieces of the semantic feature data to generate fourth pieces of the semantic feature data, wherein the plurality of portions of the semantic feature data include the second and fourth pieces of the semantic feature data. The third pieces may include some of the first pieces, the second pieces, or other pieces (e.g., intermediary pieces).

In a twenty-second aspect, alone or in combination with one or more of the above aspects, to apportion the semantic feature data into the plurality of portions of the semantic feature data, the processing system is configured to cause the wireless communication device to: perform one or more assembly operations on pieces of the semantic feature data to generate second pieces of the semantic feature data, wherein the plurality of portions of the semantic feature data include the second pieces of the semantic feature data. The pieces of the semantic feature data may be received in in IP packets.

In a twenty-third aspect, alone or in combination with one or more of the above aspects, the TB is transmitted via Physical Uplink Shared Channel (PUSCH), Physical Downlink Shared Channel (PDSCH), or a Physical Sidelink Shared Channel (PSSCH).

In a twenty-fourth aspect, alone or in combination with one or more of the above aspects, the semantic encoding: is performed in an application layer; occurs prior to a physical layer; or occurs on a PDCP layer, a RLC layer, or a MAC layer.

In a twenty-fifth aspect, alone or in combination with one or more of the above aspects, the apportioning the semantic feature data is performed in a PDCP layer, a RLC layer, or a MAC layer and based on the MCS and the resource allocation.

In a twenty-sixth aspect, alone or in combination with one or more of the above aspects, the hyperprior encoding is done at the physical layer.

In a twenty-seventh aspect, alone or in combination with one or more of the above aspects, the compressed feature probability data comprises side information for the image or video frame.

Accordingly, wireless communication devices may perform enhanced semantic communication operations for wireless communication devices. By performing enhanced semantic communication operations, throughput can be increased and latency can be reduced through improved data compression, distributed processing, or both.

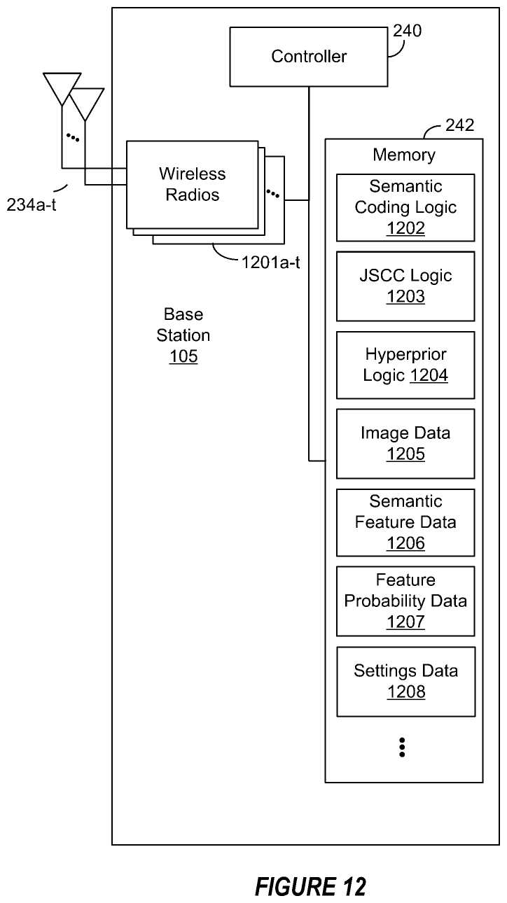

FIG. 10 is a flow diagram 1000 illustrating example blocks executed wireless communication device (e.g., a UE or network entity, such as a base station) configured according to an aspect of the present disclosure. The example blocks will also be described with respect to base station 105 as illustrated in FIG. 12. FIG. 12 is a block diagram illustrating base station 105 configured according to one aspect of the present disclosure. Base station 105 includes the structure, hardware, and components as illustrated for base station 105 of FIGS. 2 and/or 4. For example, base station 105 includes controller/processor 240, which operates to execute logic or computer instructions stored in memory 242, as well as controlling the components of base station 105 that provide the features and functionality of base station 105. Base station 105, under control of controller/processor 240, transmits and receives signals via wireless radios 1201a-t and antennas 234a-t. Wireless radios 1201a-t includes various components and hardware, as illustrated in FIG. 2 for base station 105, including modulator/demodulators 232a-t, MIMO detector 236, receive processor 238, transmit processor 220, and TX MIMO processor 230. As illustrated in the example of FIG. 12, memory 242 stores semantic coding logic 1102, JSCC logic 1203, hyperprior logic 1204, image data 1205, semantic feature data 1206, feature probability data 1207, and settings data 1208. The data (1202-1208) stored in the memory 242 may include or correspond to the data (406, 408, 442, and/or 444) stored in the memory 432 of FIG. 4.

At block 1002, a wireless communication device, such as a network device (e.g., a base station 105) or UE (e.g., UE 115), receives a TB including one or more portions of encoded image data for an image or video frame for semantic decoding and one or more corresponding portions of compressed feature probability data. The TB may include or correspond to one or more TBs of the data transmissions of FIG. 4, such the first transmission 452, the second transmission 454, or the third transmission(s) 456, or a TB as described with reference to any of FIGS. 5-8. The one or more portions of encoded image data may include or correspond to one or more of the encoded image data 444 of FIG. 4, one or more portions of the encoded image data 444a-444d of FIG. 4, the portions of encoded semantic feature data 572-574 of FIG. 5, the portions of encoded semantic feature data 692-696 of FIG. 6, or the encoded semantic feature data 752 of FIG. 7, the portions of encoded semantic feature data 752a-752c of FIG. 7, or data of one or more data units of FIG. 8. The one or more corresponding portions of compressed feature probability data may include or correspond to one or more of the feature probability data 442 of FIG. 4, the portions of compressed feature probability data 442a-442d of FIG. 4, the compressed feature probability data 544 of FIG. 5, the portions of compressed feature probability data 544a-544c of FIG. 5, the portions of compressed feature probability data 672-676 of FIG. 6, the compressed feature probability data 754 of FIG. 7, the portions of compressed feature probability data 754a-754c of FIG. 7, or data of one or more of the data units of FIG. 8. For example, the wireless communication device may receive one or more of the encoded portions of the semantic feature data from another device in a PUSCH, PDSCH, or PSSCH. To illustrate, base station 105 receives the first transmission 452 from the UE 115 via wireless radios 1201a-r and antennas 234a-t and including at least the first portion of encoded image data 444a.

At block 1004, the wireless communication device hyperprior decodes each portion of the compressed feature probability data. For example, the wireless communication device hyperprior decodes compressed feature probability data 336 as in FIG. 3. As another example, the wireless communication device hyperprior decodes portions of compressed feature probability data 544a-544c as in FIG. 5. As yet another example, the wireless communication device hyperprior decodes portions of compressed feature probability data 672-676 as in FIG. 6.

At block 1006, the wireless communication device decodes each portion of the encoded image data in association with a respective portion of a plurality of portions of the decoded feature probability data. The portions of the decoded feature probability data may include or correspond to one or more of the feature probability data 442 of FIG. 4, portions of decoded feature probability data which correspond to the portions of compressed and/or encoded feature probability data 442a-442d of FIG. 4, the portions of decoded feature probability data 562-566 of FIG. 5, the portions of decoded feature probability data 682-686 of FIG. 6, or the portions of decoded feature probability data 772-776 of FIG. 7. The respective portion of the decoded feature probability data may include or correspond to a particular portion of decoded feature data which corresponds to a same image segment or chunk as a corresponding portion of encoded image data. The portions of encoded image data and decoded feature probability data may be indicated as corresponding by index information identifying a particular chunk of the image. For example, the wireless communication device may JSCC decode encoded semantic feature data, as in FIG. 3, or may JSCC decode portions of encoded semantic feature data as described with reference to FIGS. 5 and 6.

The decoding or JSCC decoding is performed in association with the decoded feature probability data, such as based on or in accordance with the decoded feature probability data. The decoding of encoded portions of semantic feature data may generate corresponding portions of decoded semantic feature data (semantic feature data). The semantic feature data may be further decoded by a semantic decoder. The decoded image data generated by decoding the encoded image data may include or correspond to JSCC decoded semantic feature data for further semantic decoding, such as semantic feature data 334, semantic feature data 408, semantic feature data 542, semantic feature data 652, etc. In other implementations, the decoded image data corresponds to semantically decoded image data, such as image data 332, image data 406, etc.

The wireless communication device (e.g., such as a UE or base station) may execute additional blocks (or the wireless communication device may be configured further perform additional operations) in other implementations. For example, the wireless communication device may perform one or more operations as described with reference to FIGS. 3-8. As another example, the wireless communication device may perform one or more aspects as described above with reference to FIGS. 9 and 11 or one or more aspects as presented below.

In a first aspect, the plurality of portions of the encoded image data for semantic decoding and the one or more corresponding portions of compressed feature probability data correspond to a portion of the image or video frame.

In a second aspect, alone or in combination with the first aspect, the processing system is further configured to cause the wireless communication device to: receive a plurality of TBs each TB of the plurality of TBs including one or more second portions of encoded image data for semantic decoding and one or more second portions of second compressed feature probability data corresponding to the one or more second portions of encoded image data.

In a third aspect, alone or in combination with one or more of the above aspects, the processing system comprises a plurality of hyperprior decoders, and wherein to hyperprior decode each portion of the compressed feature probability data, the processing system is configured to cause the wireless communication device to: hyperprior decode, by a first hyperprior decoder of the plurality of hyperprior decoders, a first portion of the compressed feature probability data to generate a first portion of decoded feature probability data; and hyperprior decode, by a second hyperprior decoder the plurality of hyperprior decoders, a second portion of the compressed feature probability data to generate a second portion of decoded feature probability data.

In a fourth aspect, alone or in combination with one or more of the above aspects, to hyperprior decode each portion of the compressed feature probability data, the processing system is configured to cause the wireless communication device to: uncompress each portion of the compressed feature probability data in association with hyperprior decoding model information.

In a fifth aspect, alone or in combination with one or more of the above aspects, to decode each portion of the encoded image data, the processing system is configured to cause the wireless communication device to generate a plurality of portions of semantic feature data for semantic decoding, and wherein the processing system is further configured to cause the wireless communication device to: apportion the portions of semantic feature data for semantic decoding to generate a plurality of second portions of semantic feature data for semantic decoding; generate one or more packets based on the plurality of second portions of semantic feature data; and provide the one or more packets to a semantic decoder.

In a sixth aspect, alone or in combination with one or more of the above aspects, the one or more corresponding portions of the compressed feature probability data comprise encoded compressed feature probability data, and wherein the processing system is further configured to cause the wireless communication device to: channel decode the one or more corresponding portions of the encoded compressed feature probability data to generate one or more corresponding portions of partially-encoded compressed feature probability data; and entropy decode the one or more corresponding portions of the partially-encoded compressed feature probability data to generate the one or more corresponding portions of the compressed feature probability data.

In a seventh aspect, alone or in combination with one or more of the above aspects, to decode each portion of the encoded image data, the processing system is configured to cause the wireless communication device to generate a plurality of portions of semantic feature data for semantic decoding, and wherein the processing system is further configured to cause the wireless communication device to: semantically decode each portion of the plurality of portions of the semantic feature data to generate corresponding portions of image data for the image or video frame; and combine the portions of the image data to generate the image data.

In an eighth aspect, alone or in combination with one or more of the above aspects, to decode each portion of the encoded image data, the processing system is configured to cause the wireless communication device to generate a plurality of portions of semantic feature data for semantic decoding, and wherein the processing system is further configured to cause the wireless communication device to: combine the plurality of portions of the semantic feature data to generate combined semantic feature image data; and semantically decode the combined semantic feature image data to generate image data for the image or video frame.

Accordingly, wireless communication devices may perform enhanced semantic communication operations for wireless communication devices. By performing enhanced semantic communication operations, throughput can be increased and latency can be reduced through improved data compression, distributed processing, or both.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-12 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, some other implementations are within the scope of the following claims. In some cases, the actions recited in the claims can be performed in a different order and still achieve desirable results.

As used herein, including in the claims, the term “or,” when used in a list of two or more items, means that any one of the listed items can be employed by itself, or any combination of two or more of the listed items can be employed. For example, if a composition is described as containing components A, B, or C, the composition can contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

1. A wireless communication device, comprising:
a processing system that includes processor circuitry and memory circuitry that stores code and is coupled with the processor circuitry, the processing system configured to cause the wireless communication device to:
apportion semantic feature data associated with a semantically-encoded image or video frame into a plurality of portions in accordance with a modulation and coding scheme (MCS) and a resource allocation;
hyperprior decode compressed feature probability data associated with the semantic feature data;
encode each portion of the plurality of portions of the semantic feature data in association with a respective portion of a plurality of portions of the decoded feature probability data; and
transmit a transport block (TB) that includes one or more of the encoded portions of the semantic feature data.

2. (canceled)

3. The wireless communication device of claim 1, wherein the processing system is further configured to cause the wireless communication device to:
receive the compressed feature probability data with the semantic feature data in a plurality of packets; or
generate the compressed feature probability data in association with encoding the semantic feature data.

4. The wireless communication device of claim 1, wherein the processing system is further configured to cause the wireless communication device to:
semantically encode raw image data of the image or video frame to generate the semantic feature data; and
hyperprior encode the semantic feature data to generate the compressed feature probability data.

5. The wireless communication device of claim 4, wherein to semantically encode the raw image data, the processing system is configured to cause the wireless communication device to:
transform the raw image data in an image dimension, having a height, a width, and a number of color channels, to the semantic feature data in a feature space dimension, having a height, a width, and a weight, in association with semantic encoding model information, wherein the feature space dimension has a reduced value for the height and the width as compared to a corresponding value for the height and the width of the image dimension, and has an increased value for the weight as compared to a corresponding value of the color channel of the image dimension.

6. The wireless communication device of claim 1, wherein the processing system is further configured to cause the wireless communication device to:
hyperprior encode the semantic feature data to generate the compressed feature probability data prior to the apportionment of the semantic feature data in association with hyperprior encoding model information.

7. The wireless communication device of claim 6, wherein to hyperprior encode the semantic feature data, the processing system is configured to cause the wireless communication device to:
identify features of the semantic feature data in association with the hyperprior encoding model information;
determine a probability for each feature of the semantic feature data in association with the hyperprior encoding model information; and
output the compressed feature probability data indicating the probability for each feature of the semantic feature data in an encoded format.

8. (canceled)

9. The wireless communication device of claim 1, wherein the processing system is further configured to cause the wireless communication device to:
receive the compressed feature probability data; and
segment the compressed feature probability data into a plurality of portions, each portion of the compressed feature probability data representing a respective portion of an image represented by the image or video frame and associated with a respective portion of the semantic feature data of the plurality of portions of the semantic feature data.

10. The wireless communication device of claim 1, wherein:
the processing system is further configured to cause the wireless communication device to hyperprior encode each portion of the plurality of portions of the semantic feature data to generate a respective portion of the compressed feature probability data in association with hyperprior encoding model information; and
to hyperprior decode the compressed feature probability data, the processing system is configured to cause the wireless communication device to hyperprior decode each portion of the compressed feature probability data to generate the respective portion of the plurality of portions of the decoded feature probability data in association with hyperprior decoding model information.

11. (canceled)

12. (canceled)

13. (canceled)

14. The wireless communication device of claim 1, wherein to apportion the semantic feature data into the plurality of portions of the semantic feature data, the processing system is configured to cause the wireless communication device to:
segment the semantic feature data into the plurality of portions of the semantic feature data;
segment the compressed feature probability data into a plurality of respective portions of compressed feature probability data;
assign one or more portions of the semantic feature data and the respective one or more portions of the compressed feature probability data to a service data adaption protocol (SDAP) service data unit (SDU); and
generate one or more packet data convergence protocol (PDCP) SDUs based on the SDAP SDU and SDAP header information.

15. The wireless communication device of claim 1, wherein to apportion the semantic feature data into the plurality of portions of the semantic feature data, the processing system is configured to cause the wireless communication device to:
segment the semantic feature data into the plurality of portions of the semantic feature data;
segment the compressed feature probability data into a plurality of respective portions of compressed feature probability data;
assign one or more portions of the semantic feature data and the respective one or more portions of the compressed feature probability data to a packet data convergence protocol (PDCP) service data unit (SDU); and
generate one or more radio link control (RLC) SDUs based on the PDCP SDU and PDCP header information.

16. The wireless communication device of claim 1, wherein to apportion the semantic feature data into the plurality of portions of the semantic feature data, the processing system is configured to cause the wireless communication device to:
segment the semantic feature data into the plurality of portions of the semantic feature data;
segment the compressed feature probability data into a plurality of respective portions of compressed feature probability data;
assign one or more portions of the semantic feature data and the respective one or more portions of the compressed feature probability data to a radio link control (RLC) service data unit (SDU); and
generate one or more medium access control (MAC) SDUs based on the RLC SDU and RLC header information.

17. (canceled)

18. The wireless communication device of claim 1, wherein:
the TB further includes one or more portions of the compressed feature probability data corresponding to the one or more encoded portions of the semantic feature data; and
the processing system is configured to cause the wireless communication device to transmit a plurality of TBs, including the TB, each TB of the plurality of TBs including one or more second encoded portions of the semantic feature data and one or more second portions of second compressed feature probability data corresponding to the one or more second encoded portions of the semantic feature data.

19. (canceled)

20. The wireless communication device of claim 1, wherein to apportion the semantic feature data into the plurality of portions of the semantic feature data, the processing system is configured to cause the wireless communication device to:
perform one or more segmentation operations on first pieces of the semantic feature data to generate second pieces of the semantic feature data; and
perform one or more assembly operations on third pieces of the semantic feature data to generate fourth pieces of the semantic feature data, wherein the plurality of portions of the semantic feature data include the second and fourth pieces of the semantic feature data.

21. The wireless communication device of claim 1, wherein to apportion the semantic feature data into the plurality of portions of the semantic feature data, the processing system is configured to cause the wireless communication device to:
perform one or more assembly operations on pieces of the semantic feature data to generate second pieces of the semantic feature data, wherein the plurality of portions of the semantic feature data include the second pieces of the semantic feature data.

22. A wireless communication device, comprising:
a processing system that includes one or more processors and one or more memories coupled with the one or more processors, the processing system configured to cause the wireless communication device to:
receive a transport block (TB) including one or more portions of encoded image data for an image or video frame for semantic decoding and one or more corresponding portions of compressed feature probability data;
hyperprior decode each portion of the compressed feature probability data; and
decode each portion of the encoded image data in association with a respective portion of a plurality of portions of the decoded feature probability data.

23. The wireless communication device of claim 22, wherein the plurality of portions of the encoded image data for semantic decoding and the one or more corresponding portions of compressed feature probability data correspond to a portion of the image or video frame.

24. The wireless communication device of claim 22, wherein the processing system is further configured to cause the wireless communication device to:
receive a plurality of TBs each TB of the plurality of TBs including one or more second portions of encoded image data for semantic decoding and one or more second portions of second compressed feature probability data corresponding to the one or more second portions of encoded image data.

25. The wireless communication device of claim 22, wherein the processing system comprises a plurality of hyperprior decoders, and wherein to hyperprior decode each portion of the compressed feature probability data, the processing system is configured to cause the wireless communication device to:
hyperprior decode, by a first hyperprior decoder of the plurality of hyperprior decoders, a first portion of the compressed feature probability data to generate a first portion of decoded feature probability data; and
hyperprior decode, by a second hyperprior decoder the plurality of hyperprior decoders, a second portion of the compressed feature probability data to generate a second portion of decoded feature probability data.

26. The wireless communication device of claim 22, wherein to hyperprior decode each portion of the compressed feature probability data, the processing system is configured to cause the wireless communication device to:
uncompress each portion of the compressed feature probability data in association with hyperprior decoding model information.

27. (canceled)

28. The wireless communication device of claim 22, wherein the one or more corresponding portions of the compressed feature probability data comprise encoded compressed feature probability data, and wherein the processing system is further configured to cause the wireless communication device to:
channel decode the one or more corresponding portions of the encoded compressed feature probability data to generate one or more corresponding portions of partially-encoded compressed feature probability data; and
entropy decode the one or more corresponding portions of the partially-encoded compressed feature probability data to generate the one or more corresponding portions of the compressed feature probability data.

29. (canceled)

30. (canceled)
